(19) United States
(12) Patent Application Publication
(10) Pub. No.: US 2026/0301417 A1
(43) Pub. Date: Oct. 1, 2026

(54) SYSTEM AND METHOD FOR ENVIRONMENT PERCEPTION

(71) Applicant: Torc Robotics, Inc., Blacksburg, VA (US)

(72) Inventor: Kevin Paul Diomedi, Blacksburg, VA (US)

(21) Appl. No.: 19/089,336

(22) Filed: Mar. 25, 2025

(51) Int. Cl. G06V 20/58; B60R 11/04; B60W 60/00

(52) U.S. Cl. CPC G06V 20/58; B60R 11/04; B60W 60/00259

(57) ABSTRACT

A system for environment perception is provided. The system includes sensors associated with a vehicle and configured to detect objects in an environment surrounding the vehicle. The system includes a processing device configured to perform operations including generating a grid representative of the environment surrounding the vehicle, the grid including a plurality of cells, and assigning a first cell of the plurality of cells to a first object in the environment, the first object determined to have a velocity below a threshold value. The operations include assigning a single birth particle to the first object to identify the first object as a static object, assigning a second cell of the plurality of cells to a second object in the environment, the second object determined to have a velocity above the threshold value, and assigning multiple birth particles to the second object to identify the second object as a dynamic object.

### TECHNICAL FIELD

The field of the disclosure relates to environment perception and, in particular, to a system using static and dynamic occupancy grids to operate at high vehicle speeds and accurately estimate vehicle and object speeds in an environment.

### BACKGROUND

Autonomous vehicles employ fundamental technologies such as, perception, localization, behaviors and planning, and control. Perception technologies enable an autonomous vehicle to sense and process its environment. Perception technologies process a sensed environment to identify and classify objects, or groups of objects, in the environment, for example, pedestrians, vehicles, or debris. Localization technologies determine, based on the sensed environment, for example, where in the world, or on a map, the autonomous vehicle is located. Localization technologies process features in the sensed environment to correlate, or register, those features to known features on a map. Localization technologies may rely on inertial navigation system (INS) data. Behaviors and planning technologies determine how to move through the sensed environment to reach a planned destination. Behaviors and planning technologies process data representing the sensed environment and localization or mapping data to plan maneuvers and routes to reach the planned destination for execution by a controller or a control module. Controller technologies use control theory to determine how to translate desired behaviors and trajectories into actions undertaken by the vehicle through its dynamic mechanical components. This includes steering, braking and acceleration.

Traditional deployed advanced driver assistance system (ADAS) perception systems generally rely on aerospace-inspired Kalman filter-based tracking systems which track “objects” that consist of discrete entities in the vicinity of the vehicle. Typical tracked values include position, heading, velocity, and extent (size and shape). The ADAS perception systems have failure modes for occlusion, dense scenes (such as urban environments), non-rectangular objects (such as highway jersey barriers which have “infinite” extend beyond the field-of-view of the sensing system), and complex geometries not well-represented by a single bounding box.

To overcome these deficiencies, grid-based systems have been developed, beginning with static occupancy grids which capture non-dynamic objects, and more recently dynamic occupancy grids. These systems are different in that they discretize the space around the vehicle and keep track of quantities of interest of that region of space, such as whether it is occupied and, in the case of dynamic grids, if there is motion there (including what direction and how fast). The dynamic grids generally suffer from high computational complexity which restricts their usage to short-range, requiring low vehicle speeds as well as low speeds of perceived actors in the environment. Additionally, dynamic grids suffer from low-precision in the estimates of velocity due to a number of factors, which can lead to falsely reported velocities. These falsely reported velocities can lead to incorrectly reporting stationary objects as moving, as well as over or underestimated velocities leading to over or under-braking of the vehicle. As a result, traditional dynamic grid based perception systems lack reliability.

Accordingly, there exists a need for a system and a method for dynamic occupancy mapping for longer ranges and accurate velocity estimations, which would permit higher vehicle and actor speeds. These and other needs are met by the exemplary system for dynamic occupancy mapping discussed herein.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY

In one aspect, an exemplary perception system for providing dynamic occupancy mapping for a vehicle is provided. The system can be used for an autonomous vehicle, a semi-autonomous vehicle, a non-autonomous vehicle, or combinations thereof. The system includes a plurality of sensors configured to generate sensor data associated with a surrounding environment of the vehicle. The system includes at least one processor configured to receive the sensor data. The processor is configured to generate, based on the sensor data, a static occupancy grid of the surrounding environment. The static occupancy grid includes a plurality of static grid cells each associated with a different portion of the surrounding environment. One or more static grid cells of the plurality of static grid cells include static information about at least one static object in the surrounding environment represented by the one or more static grid cells. The processor is configured to generate, based on the sensor data and the static occupancy grid, a dynamic occupancy grid associated with the surrounding environment. The dynamic occupancy grid includes a plurality of dynamic grid cells each associated with the different portion of the surrounding environment. One or more dynamic grid cells of the plurality of dynamic grid cells include (i) dynamic information about at least one dynamic object in the surrounding environment represented by the one or more dynamic grid cells, and (ii) the static information about the at least one static object in the surrounding environment represented by the one or more static grid cells.

The at least one processor is further configured to represent the dynamic information using a plurality of dynamic particles, each defining at least one of a velocity and a direction for the at least one dynamic object represented by the one or more dynamic grid cells. The processor is further configured to represent the static information using one or more static particles, each defining a velocity of zero for the at least one static object represented by the one or more static grid cells. The processor is further configured to limit a total number of the plurality of dynamic particles for the dynamic occupancy grid based on a computational capacity of the at least one processor.

The processor is further configured to vary a mass of the plurality of dynamic particles based on a probability of presence of the at least one dynamic object represented by the one or more dynamic grid cells. The processor is further configured to vary a mass of the one or more static particles based on a probability of presence of the at least one static object represented by the one or more static grid cells. The one or more static particles can include one static particle. The processor is further configured to operate the vehicle in the surrounding environment based on the dynamic occupancy grid.

In another aspect, an exemplary method of providing dynamic occupancy mapping for a vehicle is provided. The method includes receiving sensor data associated with a surrounding environment of the vehicle. The method includes generating, based on the sensor data, a static occupancy grid of the surrounding environment. The static occupancy grid includes a plurality of static grid cells each associated with a different portion of the surrounding environment. One or more static grid cells of the plurality of static grid cells include static information about at least one static object in the surrounding environment represented by the one or more static grid cells. The method includes generating, based on the sensor data and the static occupancy grid, a dynamic occupancy grid associated with the surrounding environment. The dynamic occupancy grid includes a plurality of dynamic grid cells each associated with the different portion of the surrounding environment. One or more dynamic grid cells of the plurality of dynamic grid cells include (i) dynamic information about at least one dynamic object in the surrounding environment represented by the one or more dynamic grid cells, and (ii) the static information about the at least one static object in the surrounding environment represented by the one or more static grid cells.

Generating the dynamic occupancy grid further includes representing the dynamic information using a plurality of dynamic particles, each defining at least one of a velocity and a direction for the at least one dynamic object represented by the one or more dynamic grid cells, and representing the static information using one or more static particles, each defining a velocity of zero for the at least one static object represented by the one or more static grid cells. Representing the dynamic information further includes limiting a total number of the plurality of dynamic particles for the dynamic occupancy grid based on a computational capacity of at least one processor implementing the method.

Representing the dynamic information further includes varying a mass of the plurality of dynamic particles based on a probability of presence of the at least one dynamic object represented by the one or more dynamic grid cells. Representing the static information further includes varying a mass of the one or more static particles based on a probability of presence of the at least one static object represented by the one or more static grid cells. The one or more static particles can include one static particle. The method can include operating the vehicle in the surrounding environment based on the dynamic occupancy grid.

In another aspect, an exemplary vehicle is provided. The vehicle includes at least one sensor configured to generate sensor data associated with a surrounding environment of the vehicle. The vehicle includes at least one processor. The vehicle includes at least one memory configured to store programmed instructions which, when executed by the at least one processor, are configured to cause the at least one processor to receive the sensor data. Execution of the instructions causes the processor to generate, based on the sensor data, a static occupancy grid of the surrounding environment including a plurality of static grid cells that include static information about at least one static object in the surrounding environment represented by one or more of the plurality of static grid cells. Execution of the instructions causes the processor to generate, based on the sensor data and the static occupancy grid, a dynamic occupancy grid of the surrounding environment including a plurality of dynamic group cells that include (i) dynamic information about at least one dynamic object in the surrounding environment represented by one or more of the plurality of dynamic grid cells, and (ii) the static information about the at least one static object in the surrounding environment represented by the one or more of the plurality of static grid cells. Execution of the instructions causes the processor to operate the vehicle in the surrounding environment based on the dynamic occupancy grid.

The programmed instructions are further configured, when executed by the at least one processor, to cause the at least one processor to represent the dynamic information using a plurality of dynamic particles, each defining at least one of a velocity and a direction for the at least one dynamic object represented by the one or more of the plurality of dynamic grid cells, and represent the static information using one or more static particles, each defining a velocity of zero for the at least one static object represented by the one or more of the plurality of static grid cells.

The programmed instructions are further configured, when executed by the at least one processor, to cause the at least one processor to vary a mass of the plurality of dynamic particles based on a probability of presence of the at least one dynamic object represented by the one or more of the plurality of dynamic grid cells. The programmed instructions are further configured, when executed by the at least one processor, to cause the at least one processor to vary a mass of the one or more static particles based on a probability of presence of the at least one static object represented by the one or more of the plurality of static grid cells. The programmed instructions are further configured, when executed by the at least one processor, to cause the at least one processor to represent the one or more static particles as one static particle. The vehicle can include a truck.

In another aspect, an exemplary system for environment perception is provided. The system includes one or more sensors associated with a vehicle. The one or more sensors are configured to detect objects in an environment surrounding the vehicle. The system includes a processing device in communication with the one or more sensors. The processing device is configured to execute instructions stored in a memory to perform operations that include generating a grid representative of the environment surrounding the vehicle, the grid including a plurality of cells. The operations include assigning a first cell of the plurality of cells to a first object detected in the environment with the one or more sensors, the first object determined to have a velocity below a threshold value. The operations include assigning a single birth particle to the first object to identify the first object as a static object. The operations include assigning a second cell of the plurality of cells to a second object detected in the environment with the one or more sensors, the second object determined to have a velocity above the threshold value. The operations include assigning multiple birth particles to the second object to identify the second object as a dynamic object.

In some embodiments, the vehicle can be an autonomous vehicle, a semi-autonomous vehicle, or a non-autonomous vehicle. The grid can be a two-dimensional (2D) representation of the environment. The operations can include updating the generated grid in real-time based on movement of the vehicle through the environment. In some embodiments, the threshold value can be about 1 m/s. In some embodiments, the threshold value can be about equal to zero.

The operations can include assigning a first set of birth particles to the first object and, upon a determination that the velocity of the first object is below the threshold value, converting the first set of birth particles to the single birth particle. In some embodiments, the first set of birth particles can be equal to a number of the multiple birth particles assigned to the second object. The operations can include transferring birth particles from the first set of birth particles to the multiple birth particles associated with the second object after conversion of the first set of birth particles to the single birth particle. Transferring the birth particles from the first set of birth particles to the multiple birth particles can increase accuracy of dynamic information acquired for the second object.

Each of the multiple birth particles associated with the second object can include a velocity and a direction. The operations can include generating a true velocity and true direction of the second object based on the velocity and direction for each of the multiple birth particles associated with the second object. In some embodiments, a mass of the single birth particle assigned to the first object can be greater than a mass of each of the multiple birth particles assigned to the second object.

As the vehicle moves through the environment, the operations can include focusing movement computation on only the dynamic object and maintaining identification of the first object as a static object. In some embodiments, the operations can include assigning excess birth particles to the first object to resample dynamic characteristics associated with the first object and determine if a resampled velocity of the first object is above the threshold value. If the resampled velocity of the first object is below the threshold value, the first object can be maintained as the static object. If the resampled velocity of the first object is above the threshold value, the operations can include identifying the first object as a resampled dynamic object. In some embodiments, the operations can include updating a mass of the multiple birth particles assigned to the second object based on a probability of presence of the dynamic object.

In another aspect, an exemplary computer-implemented method for environment perception is provided. The method includes detecting objects in an environment surrounding a vehicle with one or more sensors associated with the vehicle. The method includes executing instructions stored in a memory with a processing device in communication with the one or more sensors to perform operations for environment perception. The operations include generating a grid representative of the environment surrounding the vehicle, the grid including a plurality of cells. The operations include assigning a first cell of the plurality of cells to a first object detected in the environment with the one or more sensors, the first object determined to have a velocity below a threshold value. The operations include assigning a single birth particle to the first object to identify the first object as a static object. The operations include assigning a second cell of the plurality of cells to a second object detected in the environment with the one or more sensors, the second object determined to have a velocity above the threshold value. The operations include assigning multiple birth particles to the second object to identify the second object as a dynamic object.

The operations can include assigning a first set of birth particles to the first object and, upon a determination that the velocity of the first object is below the threshold value, converting the first set of birth particles to the single birth particle. The operations can include transferring birth particles from the first set of birth particles to the multiple birth particles associated with the second object after conversion of the first set of birth particles to the single birth particle.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic perspective view of an autonomous truck.

FIG. 2 is a schematic perspective view of an autonomous truck and trailer.

FIG. 3 is a schematic side view of an autonomous truck and trailer.

FIG. 4 is a block diagram of the autonomous truck shown in FIGS. 1-3.

FIG. 5 is a block diagram of an example computing system.

FIG. 6 is a flowchart of a dynamic occupancy mapping process of an exemplary perception system.

FIG. 7 is a diagrammatic view of a perception system operation without prior knowledge of static occupancy.

FIG. 8 is a diagrammatic view of an exemplary perception system operation with prior knowledge of static occupancy.

FIG. 9 is a diagrammatic view of an exemplary perception system operation with resampling.

FIG. 10 is a diagrammatic view of an exemplary perception system operation without Doppler information.

FIG. 11 is a diagrammatic view of an exemplary perception system operation with high Doppler information (compensated).

FIG. 12 is a diagrammatic view of an exemplary perception system operation with low Doppler information (compensated).

FIG. 13 is a table of birth particles required in a cell to create a single static particle as an example of operation of the exemplary perception system.

FIG. 14 is a chart of a sum of a number of dynamic cells during experimentation.

FIG. 15 is a chart of a number of dynamic cells during experimentation.

FIG. 16 is a sum of a total velocity in a grid during experimentation.

FIG. 17 is a total velocity in a grid during experimentation.

FIG. 18 is a table of threshold values for a sum of total dynamic cells and velocity in a grid.

FIG. 19 is a table of threshold values for a maximum and average number of dynamic cells and total velocity in a grid.

FIG. 20 is a table of results for a sum of total dynamic cells and velocity in a grid for an exemplary algorithm compared to an original algorithm.

FIG. 21 is a table of results for a sum of total dynamic cells and velocity in a grid for an exemplary algorithm compared to an original algorithm, removing a trial run with reduced frames.

FIG. 22 is a flowchart of a recursion algorithm for an exemplary perception system.

FIG. 23 is a diagram of an algorithm executed by an exemplary perception system, where a time factor controls a decay of particle mass when they are predicted.

FIG. 24 is a diagram of an algorithm executed by an exemplary perception system, where if a sum of velocity of all particles in a cell is lower than expected given measurement grid input, a mass to birth new particles is created.

FIG. 25 is a diagram of an algorithm executed by an exemplary perception system, where a birth mass is used to create new particles, either sampling distribution or creating more massive, static particles (or both).

FIG. 26 is a chart of a sum of a number of dynamic cells for a γ=1e⁻¹ time decay experimentation case showing a best trial.

FIG. 27 is a chart of a number of dynamic cells for a γ=1e⁻¹ time decay experimentation case showing a best trial.

FIG. 28 is a chart of a sum of total velocity in a grid for a γ=1e⁻¹ time decay experimentation case showing a best trial.

FIG. 29 is a chart of a total velocity in a grid for a γ=1e⁻¹ time decay experimentation case showing a best trial.

FIG. 30 is a chart of a sum of a number of dynamic cells for a γ=100 time decay experimentation case showing a best trial.

FIG. 31 is a chart of a number of dynamic cells for a γ=100 time decay experimentation case showing a best trial.

FIG. 32 is a chart of a sum of total velocity in a grid for a γ=100 time decay experimentation case showing a best trial.

FIG. 33 is a chart of a total velocity in a grid for a γ=100 time decay experimentation case showing a best trial.

FIG. 34 is a chart of a sum of a number of dynamic cells for a γ=1e⁻¹ time decay experimentation case showing a worst trial.

FIG. 35 is a chart of a number of dynamic cells for a γ=1e⁻¹ time decay experimentation case showing a worst trial.

FIG. 36 is a chart of a sum of total velocity in a grid for a γ=1e⁻¹ time decay experimentation case showing a worst trial.

FIG. 37 is a chart of a total velocity in a grid for a γ=1e⁻¹ time decay experimentation case showing a worst trial.

FIG. 38 is a chart of a sum of a number of dynamic cells for a γ=100 time decay experimentation case showing a worst trial.

FIG. 39 is a chart of a number of dynamic cells for a γ=100 time decay experimentation case showing a worst trial.

FIG. 40 is a chart of a sum of total velocity in a grid for a γ=100 time decay experimentation case showing a worst trial.

FIG. 41 is a chart of a total velocity in a grid for a γ=100 time decay experimentation case showing a worst trial.

FIG. 42 is a table of results for a sum total of dynamic cells and a sum velocity in a grid for γ=1e⁻¹ and γ=100 time decay experimentation cases.

FIG. 43 is a table of results for a γ=1e⁻¹ time decay threshold for a time factor of 20 vs. a time factor of 5.

FIG. 44 is a table of results for a γ=100 time decay threshold for a time factor of 20 vs. a time factor of 5.

FIG. 45 is a box plot of results for a number of dynamic cells per frame for different static threshold γ and time factor T.

FIG. 46 is a box plot of results for a total velocity in grid per frame for different static threshold γ and time factor T.

FIG. 47 is a block diagram of an exemplary system for dynamic occupancy mapping.

FIG. 48 is a flowchart of a method for dynamic occupancy mapping.

FIG. 49 is a flowchart of a method for environment perception.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure. The following terms are used in the present disclosure as defined below.

An autonomous vehicle: An autonomous vehicle is a vehicle that is able to operate itself to perform various operations such as controlling or regulating acceleration, braking, steering wheel positioning, and so on, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA.

A non-autonomous vehicle: A non-autonomous vehicle is a vehicle that is neither an autonomous vehicle nor a semi-autonomous vehicle. A non-autonomous vehicle has an autonomy level of level-0 recognized by NHTSA.

The exemplary perception system for dynamic occupancy mapping discussed herein relies on the use of static and dynamic occupancy grids to achieve reliable perception of vehicles and objects at high speeds. The system therefore expands the region of applicability of a dynamic grid to apply grid-based methods to longer ranges, higher vehicle speeds, and higher object/other actor speeds. The system can be applied to, for example, highway based applications, such as autonomous (or semi-autonomous) trucking or driving. The system improves the accuracy and precision of velocity estimates of dynamic grid systems. The system can be used as a replacement or in combination with perception systems for ADAS or fully autonomous vehicle systems.

The system combines a static occupancy grid as a input to a dynamic occupancy grid, and uses the information from the static occupancy grid to improve the performance of the dynamic grid. The static grid has lower computational requirements (as compared to the dynamic grid), such that it can cover a larger space than the dynamic grid and tracks multiple quantities of each region of space. These quantities can include, e.g., occupancy, road surface type, elevation, classification of objects residing there, region information, or combinations thereof, while the dynamic grid can be restricted to occupancy, and kinematic properties, such as velocity/heading.

Occupancy in the static grid can be used to modify the particle birth process of the dynamic grid, which improves the velocities reported in the grid. A static particle (which includes the full mass of the birth weight that may be static) is created in each cell that contains static mass, allowing the finite number of birth particles to be used where dynamic objects may reside, improving overall performance. In particular, rather than detecting and identifying each object as dynamic (which requires significant computational abilities), the system is able to assign a single particle to known static objects to focus the computational abilities on particles assigned to dynamic objects. This allows for the system to operate faster at higher speeds to detect movement of surrounding objects.

The system therefore provides various advantages over existing perception systems. The system uses both a static and dynamic occupancy grid in tandem in a single perception system, with the static grid feeding into the dynamic grid to improve performance. The algorithm uses a static grid as an input to the dynamic grid birth particle distribution, and uses the static grid values to create a set of static birth particles which can either be a set of particles, or set to a single particle per grid cell. The algorithm can be applied to any dynamic grid method using a particle filter to represent velocities. The system generally provides a precise and faster processing time, allowing use of the system at high speeds (such as highway driving).

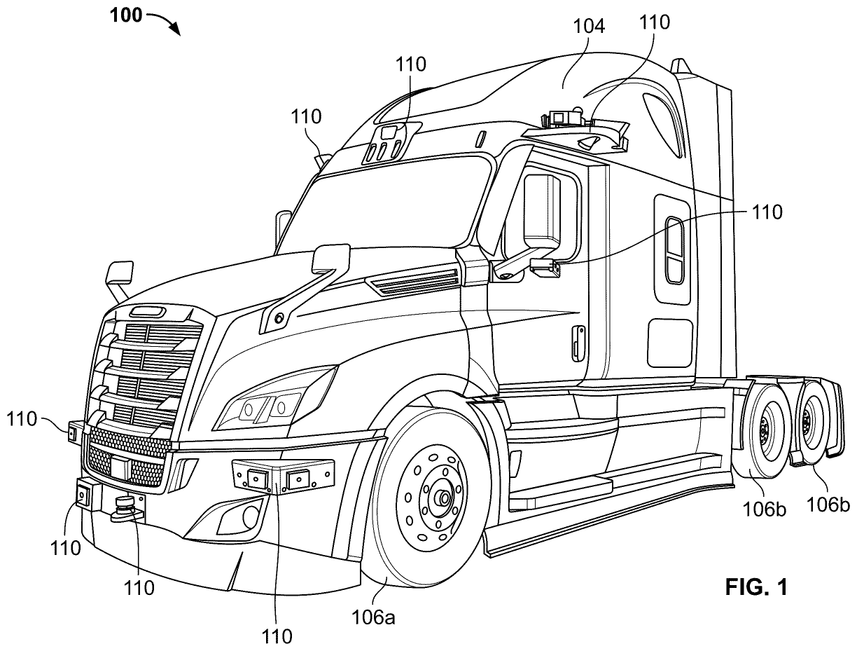

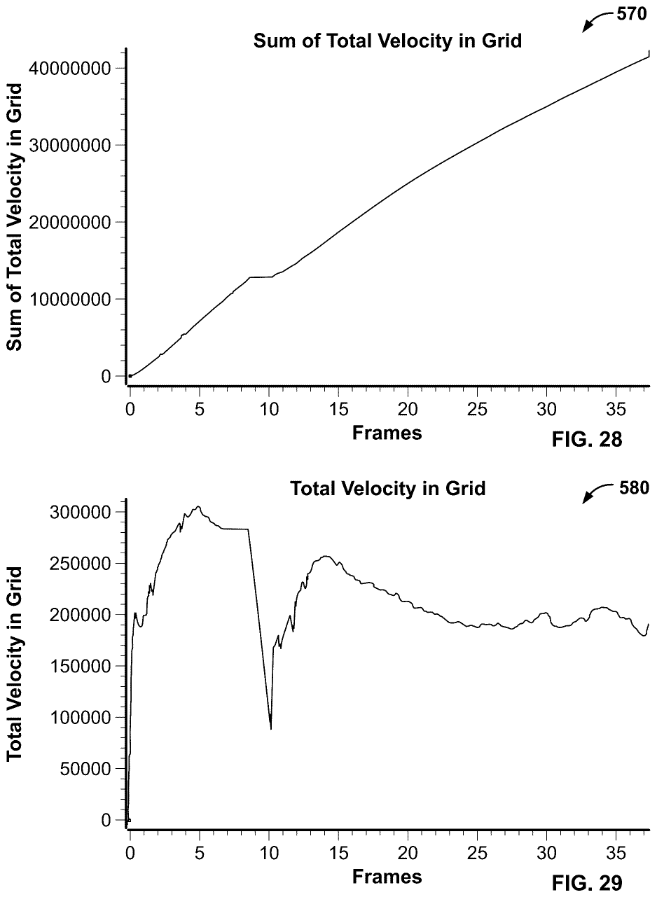

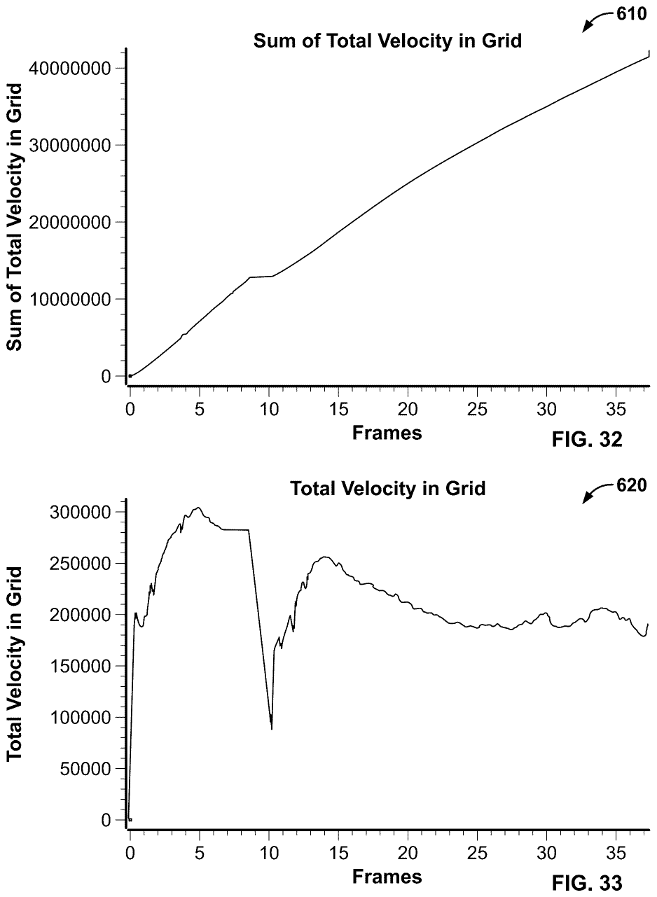

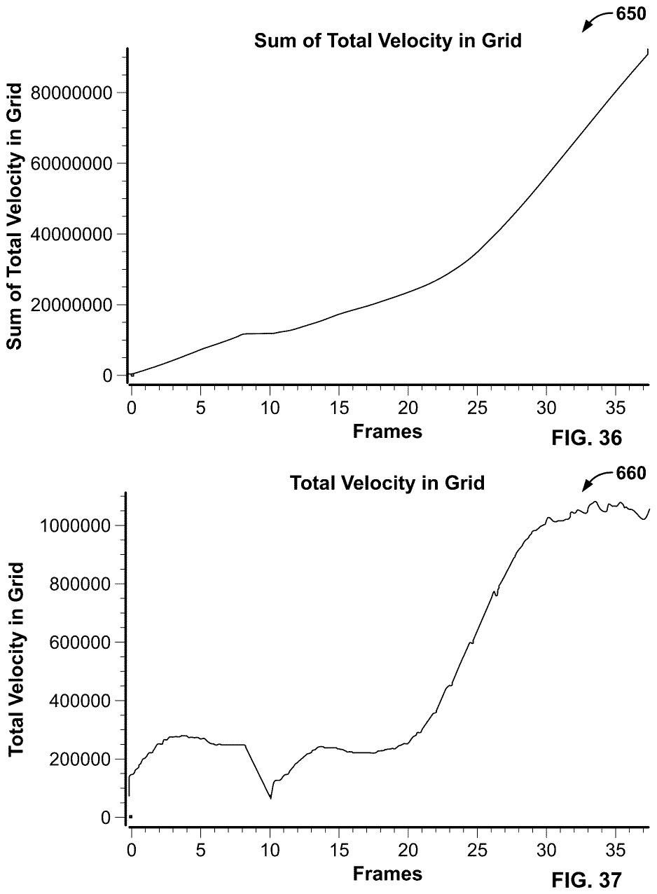

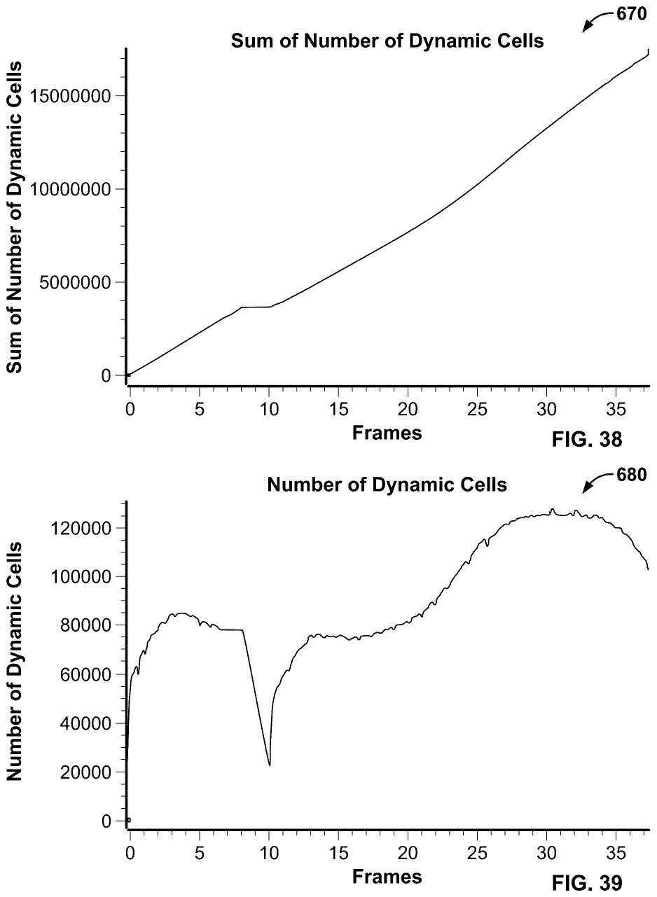

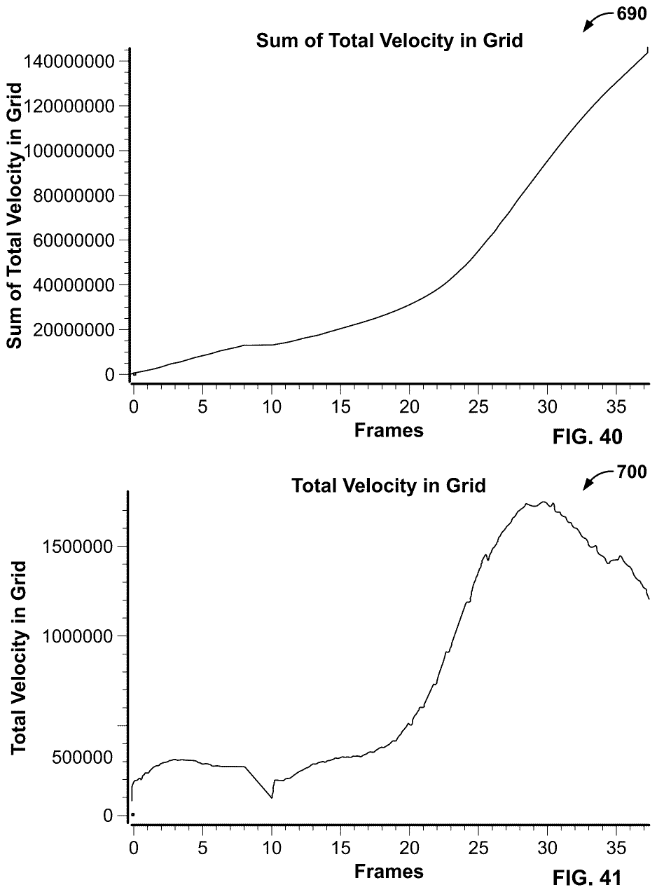

Various embodiments in the present disclosure are described with reference to FIGS. 1-49 below.

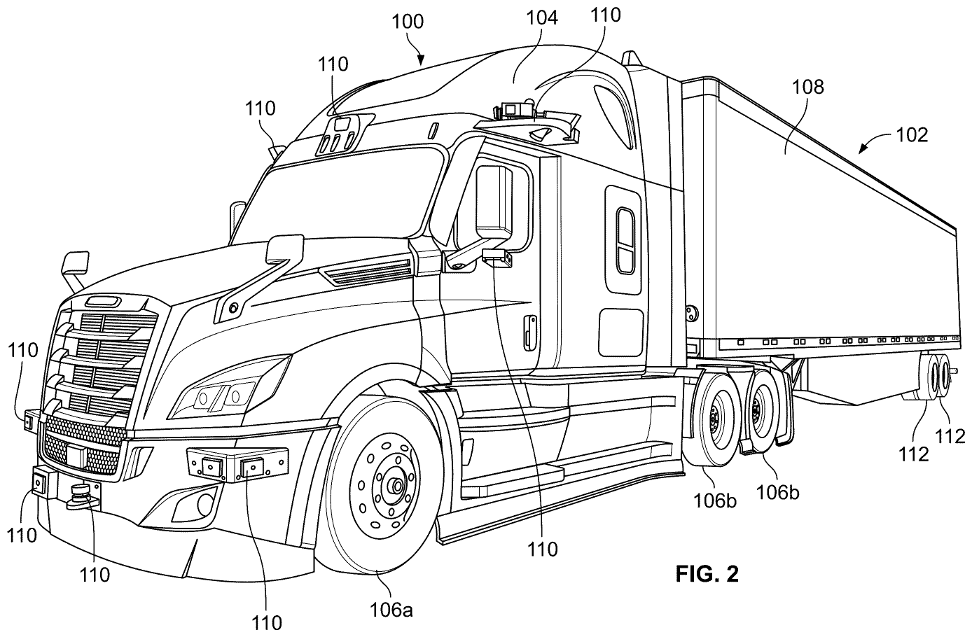

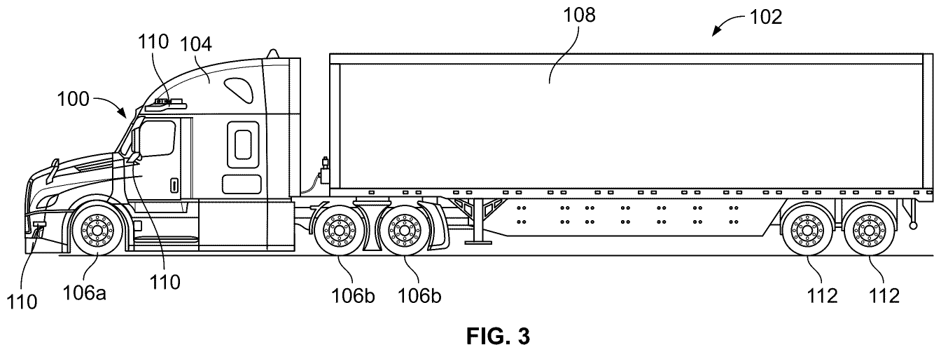

FIG. 1 is a perspective view of a vehicle 100, such as a truck that may be conventionally connected to a single or tandem trailer 102 to transport the trailer 102 to a desired location, as shown in FIGS. 2 and 3, which are, respectively, perspective and side views of the vehicle 100 of FIG. 1 with the trailer 102 attached thereto. The vehicle 100 includes a cabin 104 that can be supported, and steered in the required direction, by front wheels 106a and rear wheels 106b that are partially shown in FIG. 1. The front wheels 106a are positioned by a steering system that includes a steering wheel and a steering column (not shown). The steering wheel and the steering column may be located in the interior of cabin 104.

The vehicle 100 may be an autonomous vehicle, in which case the vehicle 100 may omit the steering wheel and the steering column to steer the vehicle 100. Rather, the vehicle 100 may be operated by an autonomy computing system of the vehicle 100 based on data collected by a sensor network including one or more sensors, e.g., sensors 110 shown in FIGS. 1-3. The vehicle 100 may additionally include a fifth-wheel coupling (not shown) to which the trailer 102 can be releasably attached. The trailer 102 can include a storage container 108 and a plurality of rear wheels 112 that support the storage container 108. It should be understood that in some embodiments the vehicle 100 and the trailer 102 can be a permanently attached as a single unit.

The sensors 110 have a field-of-view at the front, sides and/or rear of the vehicle 100. Similar sensors 110 can be used around the perimeter of the vehicle 100 to ensure full environmental coverage around the vehicle 100 is provided by the sensors 110. In some embodiments, the vehicle 100 can include, e.g., 5-6 LIDAR sensors, 8-10 cameras, combinations thereof, or the like. In some embodiments, the vehicle 100 can tow a trailer 102 and the trailer 102 can similarly include LIDAR sensors and/or cameras to provide field-of-view coverage around the perimeter of the vehicle 100 and the trailer 102. The environmental coverage by the sensors and/or cameras therefore provides data corresponding with the front, rear, sides and corners of the vehicle 100 and the trailer 102 hauled by the vehicle 100.

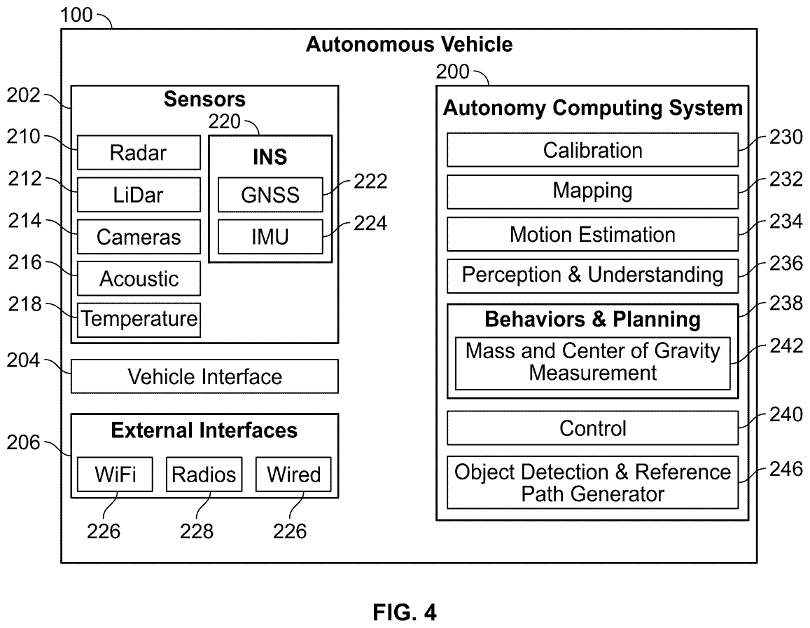

FIG. 4 is a block diagram representing autonomous vehicle 100 shown in FIGS. 1-3. In the example embodiment, autonomous vehicle 100 generally includes autonomy computing system 200, sensors 202, a vehicle interface 204, and external interfaces 206. It should be understood that the sensors 110 on the vehicle 100 in FIGS. 1-3 and described herein correspond to the sensors identified as 202 in FIG. 4. The sensors 110 may specifically comprise any of the sensors 210-220 shown in FIG. 4 and described herein.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operations of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be processed to identify one or more construction markers in the environment surrounding autonomous vehicle 100. In some embodiments, the image data generated by cameras 214 may be sent to autonomy computing system 200 or other aspects of autonomous vehicle 100 for one or more of identifying objects around the vehicle 100, updating a reference path based on the detected objects, and controlling operation of the vehicle 100 to guide the vehicle 100 along its route.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. RADAR sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw RADAR sensor data) from the emitted radio waves. In some embodiments, the system inputs from cameras 214, RADAR sensors 210, or LiDAR sensors 212 may be used in combination to identify one or more construction markers (or nodes) around autonomous vehicle 100.

GNSS receiver 222 is positioned on autonomous vehicle 100 and may be configured to determine a location of autonomous vehicle 100, which it may embody as GNSS data. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100. In some embodiments, the trailer associated with the vehicle 100 can include similar sensors 202 for gathering similar data associated with the trailer, thereby further assisting with control operations of the autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 226, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 100 may deploy with all of the data it needs to complete a mission (e.g., perception, localization, and mission planning) and may not utilize a wireless connection or other connections while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a mass and center of gravity measurement module 242, a control module or controller 240, and an object detection and reference path generator module 246. The object detection and reference path generator module 246, for example, may be embodied within another module, such as behaviors and planning module 238, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

Autonomy computing system 200 of autonomous vehicle 100 may be completely autonomous (fully autonomous) or semi-autonomous. In one example, autonomy computing system 200 can operate under Level 5 autonomy (e.g., full driving automation), Level 4 autonomy (e.g., high driving automation), or Level 3 autonomy (e.g., conditional driving automation). As used herein the term “autonomous” includes both fully autonomous and semi-autonomous.

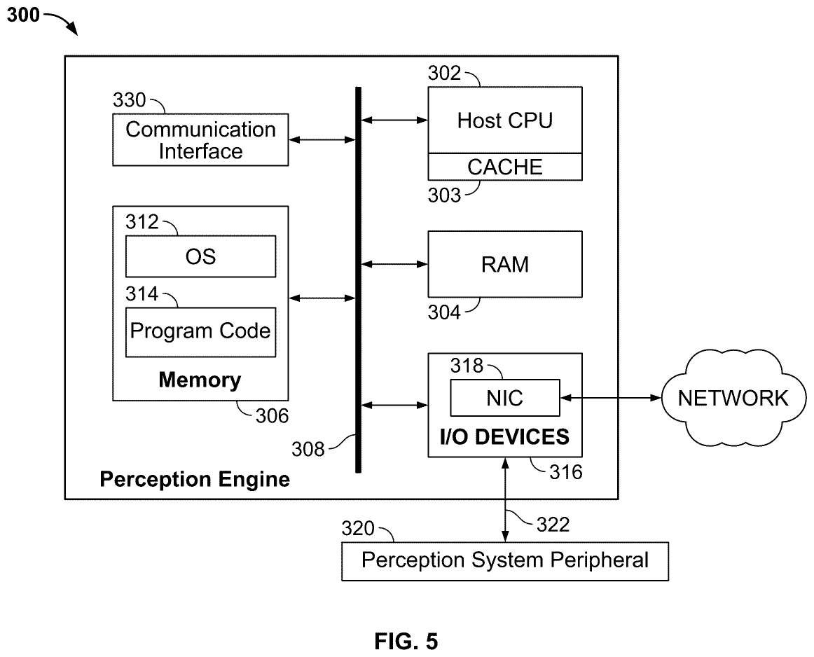

FIG. 5 is a block diagram of an example computing system 300, such as the autonomy computing system 200 shown in FIG. 4, configured for sensing an environment in which an autonomous vehicle is positioned. Computing system 300 includes a CPU 302 coupled to a cache memory 303, and further coupled to RAM 304 and memory 306 via a memory bus 308. Cache memory 303 and RAM 304 are configured to operate in combination with CPU 302. Memory 306 is a computer-readable memory (e.g., volatile, or non-volatile) that includes at least a memory section storing an OS 312 and a section storing program code 314. Program code 314 may be one of the modules in the autonomy computing system 200 shown in FIG. 4. In alternative embodiments, one or more sections of memory 306 may be omitted and the data stored remotely. For example, in certain embodiments, program code 314 may be stored remotely on a server or mass-storage device and made available over a network 332 to CPU 302.

Computing system 300 also includes I/O devices 316, which may include, for example, a communication interface such as a network interface controller (NIC) 318, or a peripheral interface for communicating with a perception system peripheral device 320 over a peripheral link 322. I/O devices 316 may include, for example, a GPU for image signal processing, a serial channel controller or other suitable interface for controlling a sensor peripheral such as one or more acoustic sensors, one or more LiDAR sensors, one or more cameras, or a CAN bus controller for communicating over a CAN bus.

The exemplary perception system for dynamic occupancy mapping discussed herein builds on previous perception systems used in the industry, particularly perception systems that use an approximate particle filter implementation of a dynamic occupancy grid. (See, e.g., Nuss, D. et al., A Random Finite Set Approach for Dynamic Occupancy Grid Map with Real-Time Application, The International Journal of Robotics Research, 37(2) (May 2016)). The dynamic occupancy grid approach creates a top-down 2-D grid that keeps track of where in space around an autonomous vehicle is occupied by objects or the static environment, and can additionally keep track of where in space moving objects reside (including their direction and speed). As noted previously, the convention perception systems encounter a large amount of computation requirements and are therefore limited to short ranges, and low-speed objects in the environment. The exemplary system improves the dynamic occupancy mapping algorithm to address these limitations, thereby expanding use to longer ranges and higher speeds.

By combining a larger, static occupancy grid (which has low computation requirements) and using it as an input to the dynamic grid to determine where static objects reside, the exemplary system algorithm reduces the computational resources spent on areas of static objects such that computational resources can be allocated where the resources are needed, i.e., in regions of dynamic objects. Mathematical derivations of the algorithm used by the system are therefore discussed herein, including examples of the application of the system on a scene that contains only static objects, showing improvements to the estimated velocities (which are known to be 0) over the whole grid and indicating improvement over conventional systems.

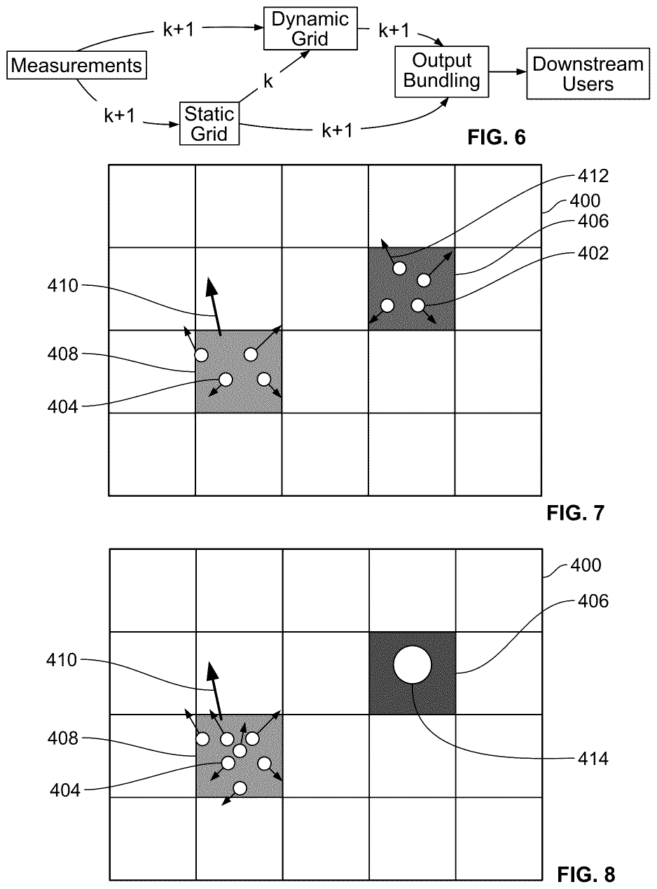

FIG. 6 is a flowchart representation of the dynamic occupancy mapping process performed by the exemplary perception system. In particular, FIG. 6 shows the interaction between the static and dynamic grid to improve the operation of the dynamic grid with information received from the static grid. Initially, measurements are taken and the static occupancy grid is generated. In this static grid, static objects are identified and a single particle is assigned to each respective static object. The output of the static occupancy grid is used with the measurement data to generate the dynamic occupancy grid. The dynamic occupancy grid assigns particles to dynamic objects to determine their size and speed, with computation focused on the dynamic objects rather than the previously assigned static objects. Outputs of both the static and dynamic occupancy grids are subsequently bundled and transmitted to users/vehicles. The dynamic grid can include the velocity and occupancy of objects. The static grid can include the classification of objects (e.g., vehicle, pedestrian, sidewalk, shoulder, tree, guardrail, or the like). Bundling allows for the information to be combined from both grids into a usable format. The static grid information from the previous cycle is therefore used as an input to the dynamic grid with the new measurement set. Alternatively, the system could sent k+1 output to the input of the dynamic grid if they are run in sequence.

FIGS. 7 and 8 are diagrammatic views of a perception system operation without prior knowledge of static occupancy (FIG. 7), and with prior knowledge of static occupancy (FIG. 8). In particular, FIG. 8 shows the solution for conventional perception system operation with the algorithmic modification. A grid 400 of the environment is generated. Each cell of the grid 400 is a representation of the environment around the vehicle as it moves through the environment (e.g., along a road), and each cell is a place where occupancy by an object may be detected. The system assumes that there are 8 birth particles 402, 404, which is a design parameter limited by both computation and tuned to reduce false (random) velocities in the grid 400. However, the system can be programmed to have more or less birth particles. The example of FIGS. 7 and 8 assumes that there are two detected occupied cells 406, 408, one from a static object (cell 406) and another from a dynamic object (cell 408 with a velocity 410). Although cell 406 is representative of a static object, because there is no prior knowledge, four birth particles 402 are used with random (false) velocities 412. The dynamic object (cell 408) having a true velocity 410 is also sampled with four birth particles 404.

If both cells 406, 408 have the same birth mass, particles 402, 404 are distributed between both cells 406, 408 equally. As used herein, the term “birth mass” or “birth weight” can be a probability value of the cell being occupied and/or the estimated speed of the object being correct relative to a previous measurement. In some embodiments, the probability value (or birth mass) can be a numerical value between 0-100. For example, the system can compare the current estimation of the object occupancy and velocity based on the previous occupancy and velocity determination. If the values are different beyond a threshold value, a higher birth weight or mass can be used (e.g., a larger number of particles assigned to the cell) to increase the confidence in the estimation in the next cycle of calculation. In this case, more birth particles than are necessary are used to capture the true velocity in the static object cell 406 (i.e., a velocity of 0 because the object is static) because sampling is made from the unknown distribution. This leads to two issues—wasting particles 402 that could sample the birth distribution in other cells (which is especially important when the birth distribution has to account for highway-speed objects) and initializing to the incorrect velocity (which will make the occupancy in the cell 406 incorrect, as well as potentially lead to false velocity confirmations and false occupancy as the algorithm evolves in time).

FIG. 8 illustrates a solution to these issues. The exemplary perception algorithm uses prior knowledge of static occupancy from a static occupancy grid to assign a single particle 414 to capture the static velocity of the static object in cell 406, which prevents the two issues above. In some embodiments, the static and dynamic occupancy grids can be generated as separate grids, or as the same grid with identification of static and dynamic particles. The single particle 414 can be greater in size as compared to the particles 402, 404, visually indicating the combination of multiple individual particles 402 and representative of the mass of the particle 414. The velocity of the cell 406 is therefore set at 0, which will not induce false confirmations. As a result, there are now more particles 404 to sample the unknown distribution in cells where there may be dynamic objects (such as cell 408). In particular, because only a single particle 414 is used for the static object, the remaining particles 404 can be used to better sample the cell 408 considered non-static (i.e., dynamic), which improves sampling the unknown birth distribution and improves capturing the true velocity 410 (e.g., true velocity and direction) of the dynamic object. The true velocity 410 can be determined based on the individual velocities and directions of each of the particles 404. This system avoids waste of particles for determination of the dynamic characteristics of other objects by assigning a single particle 414 to the static object(s). Because many objects around the vehicle may be static, this system allows for focus on computation of the dynamic objects rather than attempting to calculate the occupancy and velocity of all objects (static and dynamic) for each instance.

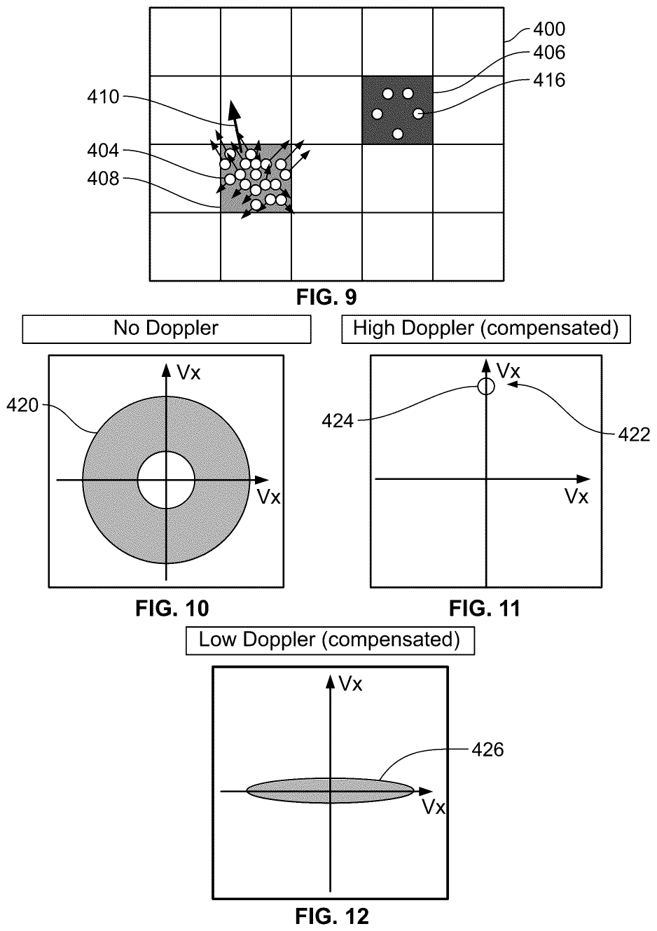

The system operation shown in FIG. 8 can be expanded with static persistent distributions and resampling, as shown in FIG. 9. After the particle birth and cell statistic tabulation, the particles can be resampled into the persistent particle 416 distribution for the static cell 406 with equal weights. The algorithm still improves performance because of the improved velocity and reduction of false confirmations, but excess persistent particles 416 can be used to represent the static mass in cell 406. In particular, the resampling feature allows for the system to determine if previously labeled static objects are now dynamic, and estimates the occupancy and velocity for such resampled particles 416. The resampling feature allows the system to change the previous label of static to dynamic for an object for accurate representation of objects detected around the vehicle. When resampling, the system can use the same number of particles 416 (e.g., same particle weight or mass) as previously used to estimate their occupancy and velocity.

Another feature available for improving operation of the exemplary perception system is the use of Doppler information, as illustrated in FIGS. 10-12. Use of Doppler with the proposed operation in FIG. 8 can increase and optimize performance of the system. For example, without Doppler information (FIG. 10), the system has no knowledge that would allow a determination of which direction the object 420 is moving. The object 420 could therefore be moving in any direction. A birth distribution with V²ₘₐₓ variance in both x and y directions would be needed. Such birth distribution may be permissible for capturing pedestrian speeds, but is not sufficiently fast and precise for highway objects moving at high speeds.

If high Doppler information is used (FIG. 11), the system can observe a large Doppler velocity near the Vₘₐₓ (422) and a determination can be made that the true velocity of the object 424 has been captured. The variance is therefore the sensor noise for the Doppler measurement. However, if low Doppler information is used (FIG. 12), the Doppler velocity (vehicle compensated) for the object 426 is near zero and, therefore, the true velocity is only constrained in the range direction and not in the cross-range direction. For velocities in-between, there is a scaling of how much velocity could be in the cross-range direction given the observed range rate through Doppler.

The exemplary system improves the performance of the dynamic occupancy grid to allow for usage in both low and high speed scenarios. The system improves the allowance of the fixed number of birth particles to regions of higher uncertainty by reducing the number capturing static objects. The system further reduces the number of particle births leading to velocity/particle blooming at the edges of dense occupied regions. The latter is also addressed by the addition of Doppler information (where available), but occlusions may still lead to issues arising when Doppler is taken into account. As previously illustrated in FIG. 6, the system incorporates information from a parallel static grid to let the dynamic grid focus its power on dynamic objects. Static objects are not completely removed, because they could be temporarily stopped dynamic actors (such as vehicles or pedestrians). In particular, static objects at one point can become dynamic actors/objects at a later point, e.g., a vehicle stopped at a traffic light until the light turns green.

### Birth Distribution Modeling

The exemplary system can include a mapping module configured to execute an algorithm for dynamic occupancy mapping. After one or more sensors of the vehicle have detected an object in the environment around the vehicle (e.g., within the field-of-view of the sensor), the system can perform this modeling step. The module can be executed to model a birth distribution represented by p_{b}(●). We assume no prior knowledge of the object in the cell except for a maximum velocity given from an operational design domain vₘₐₓ, which allows us to assume a Gaussian as follows:

$${p}_{b} ( \cdot ) \approx {N}_{p} ( {\vec{r}}^{( c )} , diag ( Δ {x}^{2} , Δ {y}^{2} ) ) \cdot {N}_{v} ( \vec{0} \cdot {v}_{max}^{2} \cdot I )$$

with p_{b}(•) a multivariate Gaussian, Nₚ the spatial variation, and Nᵥ the velocity variation.

Sampling Nᵥ requires many particles at highway speeds and is susceptible to inducing false predictions in densely occupied regions. This creates two issues—a large number of particles required, and false confirmations. To help counteract these issues, the system can use prior information, such as direct Doppler measurement of radial velocity of the detected object, static grid information prior, road structure-informed prior, and object tracker prior. This can allow for more intelligent modeling of the birth distribution as a Gaussian mixture:

$${p}_{b} ( \cdot ) \approx {\sum }_{t} {p}_{b}^{t} {N}_{t} ( \cdot , \cdot )$$

which could be composed of a sum of measurement Gaussians N_{A}(⋅,⋅) for associated measurements:

$${N}_{A} = {N}_{p} ( {\vec{r}}^{( c )} , diag ( Δ {x}^{2} , Δ {y}^{2} ) ) {\sum }_{i} {p}_{A , i} {N}_{A , i} ( {\dot{\vec{r}}}_{i} ∨ \vec{r} , C ( {v}_{max} , ∨ {\dot{\vec{r}}}_{i} ∨ \vec{r} ) )$$

each sampling the state given measurements i, and a static distribution of:

$${N}_{S} = {N}_{p} ( {\vec{r}}^{( c )} , diag ( Δ {x}^{2} , Δ {y}^{2} ) ) \cdot {N}_{vS} ( \vec{0} , {σ}_{s}^{2} \cdot I )$$

with σₛ a noise term. If σₛ→0 this reduces to the position portion only.

The road and object tracker priors can be neglected for now as they impose additional constraints on safety and induce possible cycles and consequent reduction of redundancy. If necessary, the concerns created in this could be reduced by introducing a spatial constrain on this by either only modelling these at the edges of the grid, or at edges of occluded regions. For practical application, it may be necessary to also contain a portion of the original distribution:

$${N}_{\overline{A} ⋂ \overline{S}} = {N}_{p} ( {\vec{r}}^{( c )} , diag ( Δ {x}^{2} , Δ {y}^{2} ) ) \cdot {N}_{v} ( \vec{0} \cdot {v}_{max}^{2} \cdot I )$$

Although it may appear that the algorithm has not changed the process and only increased the number of distributions to sample, the crux will come in practice with the number of particles needed to sample each distribution and their weight. We therefore have the birth distribution:

$${p}_{b} ( \cdot ) \approx {N}_{A} + {N}_{S} + {N}_{\overline{A} ∩ \overline{S}}$$

### Derivation of Birth Distribution Including Static Portion

The original implementation splits the occupied mass into persistent and birth as follows:

$${m}_{k + 1}^{( c )} = {ϱ}_{p , k + 1}^{( c )} + {ϱ}_{b , k + 1}^{( c )}$$

Further, there are a fixed number of new particles assigned to each grid cell:

$${v}_{b , k + 1}^{( c )} = {v}_{A , k + 1}^{( c )} + {v}_{\overline{A} , k + 1}^{( c )}$$

with

$${v}_{A , k + 1}^{( c )}$$

the number of associated particles sampled from N_{A} and

$${v}_{\overline{A} , k + 1}^{( c )}$$

the number of unassociated particles. This can be split further into:

$${v}_{\overline{A} , k + 1}^{( c )} = {v}_{s , k + 1}^{( c )} + {v}_{\overline{A} ∩ \overline{S} , k + 1}^{( c )}$$

with

$${v}_{s , k + 1}^{( c )}$$

the number of particles from the static distribution N_{S} and

$${v}_{\overline{A} ∩ \overline{S} , k + 1}^{( c )}$$

the number of particles with no prior knowledge, except max velocity from N_{Ā∩S̅}.

Similar to the proportion of associated to unassociated number of particles, a relationship can be defined as follows:

$$\frac{{v}_{s , k + 1}^{( c )}}{{v}_{\overline{A} ∩ \overline{S} , k + 1}^{( c )}} = \frac{{m}_{S , k}^{( c )}}{1 - {m}_{S , k}^{( c )}}$$

with

$${m}_{S , k}^{( c )}$$

the belief mass of occupied from a static grid. The system could use the pignistic transform to convert this directly to a probability which amounts to a fair guess with half of the unknown mass apportioned to occupied, or the mass directly which amounts to a pessimistic guess from the static occupied which will increase the sampling of the velocity-only determined distribution.

However, with high static belief mass, the system may over sample the static distribution N_{S}. Thus it may be preferable to use a fixed number of static particles. If there is no noise on the velocity distribution, the system only needs to sample the spatial distribution to account for discritization error of the grid. As the grid cell size is reduced, this could be converted to a single sample. Also, the tandem processing of the static and dynamic grid can also reduce the need to a single sample.

This topic will be addressed further below. However, continuing on to determine the number of particles for these three distributions and their weights and combining all of this:

$${v}_{\overline{A} ∩ \overline{S} , k + 1}^{( c )} = {v}_{S , k + 1}^{( c )} ( \frac{1 - {m}_{s , k}^{( c )}}{{m}_{s , k}^{( c )}} )$$

Rearranging gives:

$${v}_{\overline{A} , k + 1}^{( c )} = ( 1 + \frac{1 - {m}_{s , k}^{( c )}}{{m}_{s , k}^{( c )}} ) {v}_{S , k + 1}^{( c )}$$

and with:

$${v}_{b , k + 1}^{( c )} = {v}_{A , k + 1}^{( c )} + {v}_{\overline{A} , k + 1}^{( c )}$$

$${v}_{b , k + 1}^{( c )} = ( \frac{{P}_{A}^{( c )}}{1 - {P}_{A}^{( c )}} + 1 ) {v}_{\overline{A} , k + 1}^{( c )}$$

we have:

$${v}_{\overline{A} , k + 1}^{( c )} = ( 1 + \frac{{P}_{A}^{( c )}}{1 - {P}_{A}^{( c )}} ) ( 1 + \frac{1 - {m}_{s , k}^{( c )}}{{m}_{s , k}^{( c )}} ) {v}_{S}^{( c )}$$

Thus giving:

$${v}_{S}^{( c )} = {[ ( 1 + \frac{{P}_{A}^{( c )}}{1 - {P}_{A}^{( c )}} ) ( 1 + \frac{1 - {m}_{s , k}^{( c )}}{{m}_{s , k}^{( c )}} ) ]}^{- 1} {v}_{b , k + 1}^{( c )}$$

The equations below therefore provide the number of particles for the three distributions.

### Weights for the Associated Particles are:

$${w}_{A , k + 1}^{i , ( c )} = \frac{{p}_{A , k + 1}^{( c )} {ϱ}_{b , k + 1}^{( c )}}{{v}_{A , k + 1}^{( c )}}$$

### Unassociated and Static Weights:

$${w}_{S , k + 1}^{i , ( c )} = \frac{( 1 - {p}_{A , k + 1}^{( c )} ) {m}_{S , k}^{( c )} {ϱ}_{b , k + 1}^{( c )}}{{v}_{S , k + 1}^{( c )}}$$

### Unassociated and Non-Static Weights:

$${w}_{\overline{A} ⋂ \overline{S} , k + 1}^{i , ( c )} = \frac{( 1 - {p}_{A , k + 1}^{( c )} ) ( 1 - {m}_{S , k}^{( c )} ) {ϱ}_{b , k + 1}^{( c )}}{{v}_{\overline{A} ⋂ \overline{S} , k + 1}^{( c )}}$$

### Improving Dispersion of Particles Amongst Cells

With the introduction of the static particles in the manner described above, the system reduces the issue of false confirmations by reducing the size and weight of the determined unknown birth distribution sample set. However, the first issue of the large number of samples needed to represent this distribution at highway speeds, has not yet been impacted or addressed. This can be accomplished by following the advice of the note above, i.e., fixing a set number of particles for sampling the static distribution, which effectively reduces the number of particles used in grid cells with high confidence of being a static object, and allows those particles to be redistributed to regions of higher uncertainty (see, e.g., FIG. 8).

### Example

The example looks at how many birth particles would arise to give one static birth particle, assuming high occupancy

$${m}_{s , k}^{( c )} = 0.8 ,$$

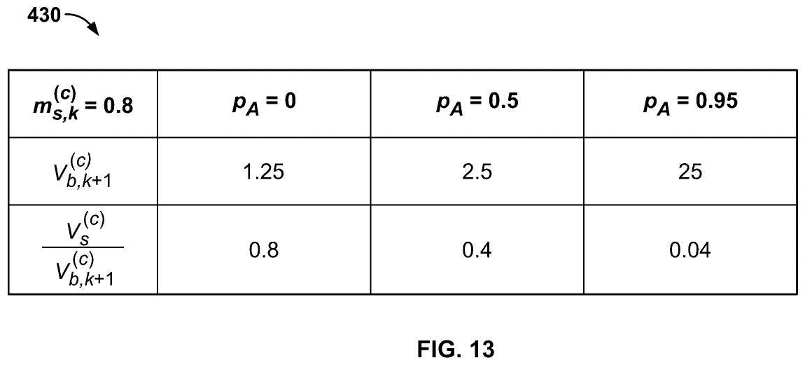

and low, high and full association. The table 430 of FIG. 13 shows the number of birth particles required in a cell to create a single static particle.

With the proportion of static particles to total birth particles, it can be seen from FIG. 13 that in the case of a non-Doppler Lidar (which does not have an associated measurement, being strictly an unassociated birth from the measurement grid) 80% of the particles go to sampling the static distribution. This reflects a huge waste in the particle distribution, e.g., if there are 10 birth particles in a cell, 8 are static; if there are 50 birth particles in a cell, then 40 are static; and if there are 100 birth particles in a cell, then 80 of them are static. By restricting to a maximum number of static birth particles, the remaining particles can be redistributed to other cells where dynamic objects may reside (see, e.g., FIG. 8).

### Fixed Number of Static Distribution Particles

In the original implementation, v_{b} is chosen as a design parameter, and then the number of particles to birth in each cell is given by:

$${v}_{b}^{( c )} = \frac{{ϱ}_{b , k + 1}^{( c )}}{{\sum }_{c} {ϱ}_{n , k + 1}^{( c )}} {v}_{b}$$

Choosing a fixed number of static birth particles

$${\hat{v}}_{s}^{( c )}$$

and plugging that back in the previously derived equations would produce a fixed value of

$${v}_{b}^{( c )} .$$

Instead, the system chooses a fixed

$${\hat{v}}_{s}^{( c )}$$

in cells with

$${m}_{S}^{( c )} \geq γ$$

for some threshold of occupied. Considering the indicator function:

$$1 ( {m}_{S}^{( c )} \cdot {ϱ}_{b , k + 1}^{( c )} \geq γ ) = \{ \begin{matrix}1 & {m}_{s}^{( c )} \cdot {ϱ}_{b , k + 1}^{( c )} \geq γ \\ 0 & {m}_{s}^{( c )} \cdot {ϱ}_{b , k + 1}^{( c )} < γ\end{matrix}$$

and noting that the birth mass has been distributed as follows:

$${ϱ}_{b , k + 1}^{( c )} = {ϱ}_{b , k + 1}^{( c )} * [ {p}_{A}^{( c )} + ( 1 - {p}_{A}^{( c )} ) {m}_{s}^{( c )} 1 ( {m}_{S}^{( c )} \cdot {ϱ}_{b , k + 1}^{( c )} \geq γ ) + ( 1 - {p}_{A}^{( c )} ) ( 1 - {m}_{s}^{( c )} 1 ( {m}_{S}^{( c )} \cdot {ϱ}_{b , k + 1}^{( c )} \geq γ ) ) ]$$

The first term on the right is the associated birth mass, the second term is the static mass, and the third term is unassociated non-static mass.

Grouping these provides:

$${ϱ}_{b , k + 1}^{( c )} = {ϱ}_{b , S , k + 1}^{( c )} + {ϱ}_{b , \overline{S} , k + 1}^{( c )}$$

With static birth weight from the second term above:

$${ϱ}_{b , S , k + 1}^{( c )} = ( 1 - {p}_{A}^{( c )} ) {m}_{s}^{( c )} 1 ( {m}_{S}^{( c )} \cdot {ϱ}_{b , k + 1}^{( c )} \geq γ )$$

And the non-static birth weight:

$${ϱ}_{b , \overline{S} , k + 1}^{( c )} = {ϱ}_{b , k + 1}^{( c )} - {ϱ}_{b , S , k + 1}^{( c )}$$

The total number of birth particles is now distributed over the static birth particles and the non-static birth particles:

$${v}_{b} = {v}_{b , \overline{S}} + {\sum }_{c} {\hat{v}}_{s}^{c} 1 ( {m}_{S}^{( c )} \cdot {ϱ}_{b , k + 1}^{( c )} \geq γ )$$

And the number of birth particles in a particular cell can be given as:

$${v}_{b , \overline{S}}^{( c )} = \frac{{ϱ}_{b , \overline{S} , k + 1}^{( c )}}{{\sum }_{c} {ϱ}_{b , \overline{S} , k + 1}^{( c )}} {v}_{b , \overline{S}}$$

The system can re-use the original equations for the number of particles associated/not associated with our new number of birth particles as:

$${v}_{A , k + 1}^{( c ) ′} = {v}_{b , \overline{S}}^{( c )} {p}_{a}$$

$${v}_{A ⋂ \overline{S} , k + 1}^{( c ) ′} = {v}_{b , \overline{S}}^{( c )} - {v}_{A}^{( c ) ′}$$

which can be inserted into the equations derived above while including the indicator portion of the static mass to obtain the proper weights:

### Weights for the Associated Particles are:

$${w}_{A , k + 1}^{i , ( c )} = \frac{{p}_{A , k + 1}^{( c )} {ϱ}_{b , k + 1}^{( c )}}{{v}_{A , k + 1}^{( c ) ′}}$$

### Unassociated and Static Weights are:

$${w}_{S , k + 1}^{i , ( c )} = \frac{( 1 - {p}_{A , k + 1}^{( c )} ) {m}_{S , k}^{( c )} 1 ( {m}_{S}^{( c )} \cdot {ϱ}_{b , k + 1}^{( c )} \geq γ ) {ρ}_{b , k + 1}^{( c )}}{{\hat{v}}_{S}^{( c )}}$$

### Unassociated and Non-Static Weights are:

$${w}_{\overline{A} ⋂ \overline{S} , k + 1}^{i , ( c )} = \frac{( 1 - {p}_{A , k + 1}^{( c )} ) ( 1 - {m}_{S , k}^{( c )} 1 ( {m}_{S}^{( c )} \cdot {ϱ}_{b , k + 1}^{( c )} \geq γ ) {ϱ}_{b , k + 1}^{( c )}}{{v}_{A ⋂ \overline{S} , k + 1}^{( c ) ′}}$$

Since the system is running with a both a static and dynamic grid simultaneously, the system can elect to use a single particle to represent all the static mass in a cell (see FIG. 8), because if the dynamic grid misplaces the location of an object by a grid cell due to the evolving vehicle motion (e.g., particle did not quite fall into the right grid cell) the static grid will still contain the object. Alternatively, the grid cell size can be reduced.

### Algorithm Details

As noted above, the exemplary algorithm builds upon and improves the new particle initialization discussed in, e.g., (See, e.g., Nuss, D. et al., A Random Finite Set Approach for Dynamic Occupancy Grid Map with Real-Time Application, The International Journal of Robotics Research, 37(2) (May 2016)). Under step 2, the exemplary system/algorithm additionally accumulates:

$${\hat{v}}_{s}^{( c )} 1 ( {m}_{S , k}^{( c )} \cdot {ϱ}_{b , k + 1}^{( c )} \geq γ )$$

with an exclusive scan (e.g., kernel fused with the birth weight accumulation). The static birth weight is subtracted while doing the birth weight accumulation, i.e., instead of summing

$${ϱ}_{b}^{( c )}$$

directly, sum:

$${ϱ}_{b}^{( c )} [ 1 - ( 1 - {p}_{A}^{( c )} ) {m}_{S , k}^{( c )} 1 ( {m}_{S , k}^{( c )} \cdot {ϱ}_{b , k + 1}^{( c )} \geq γ ) ]$$

Under step 3, the system normalizes to v_{b,S̅} instead of v_{b}. Under steps 5 and 6, the system adds the accumulated static particles from step 2 to the start/stop positions. Under steps 11 and 12, equations 13 and 15 from Nuss et al. are used for the birth weights. Under steps 13 and beyond, weight and position for the static particles is stored.

An experiment was performed to analyze the effect of the algorithm modifications on performance demonstrating improvements with up to a 10% decrease in the number of dynamic cells and 30% decrease in the amount of the velocity in the grid versus the original (Nuss et al.) algorithm.

During experimentation, the probability of association P_{A} factor was dropped as there were no Doppler measurements. Additionally, the cell birth mass was brought into the indicator function, leading to a difficult to set parameter for the threshold that may not always be optimally set (e.g., may have too many or too few static birth particles). The need for setting the threshold in this way can be removed by treating static particles completely separately. This would have further improvements in computation and eliminate the problem detailed in the diagram of FIG. 9 where the massive birth particles are resampled into the persistent particle distribution. Performance improvements are still obtained because there are significantly more persistent particles than birth particles and the velocity initialization is improved. The process can be extended to all particles which will improve computation and accuracy.

### Experimentation

Experimentation was performed for testing of static birth distributions and indicator thresholds using the dynamic occupancy grid. The experimentation was intended to determine if separating the static mass into separate birth particles has any impact on the system operation, and to examine how this impacts the resultant velocity of the grid.

Ground truth data was generated for experimentation purposes for completely static scenes. These scenes include static scenes and velocity from objects from an object tracker placed into the grid. Initially, a completely static scene was reviewed. The system was used to review the total velocity in the grid, total dynamic cells (velocity magnitude greater than threshold), and the running sum of both of these quantities vs time. The running sum of each gave a single number to compare—the final value of each—which can be divided by the number of frames (which is variable) to give an average value per frame.

These values are presented as the total, as well as divided by the number of frames computed in the sequence. The values can be normalized by the number of occupied cells, which gives an average velocity per cell. This can be done for the static cells. For dynamic cells, a review of the velocity error and total erroneous cells can be reviewed. The values computed in the results discussed below are given as follows. For each of the results, lower is better. One of the reasons for this is because the scene chosen is known to be 100% static with no dynamic objects.

The number of dynamic cells is calculated by the equation below. The system is used to count the number of cells for each frame that had a velocity magnitude greater than 1 m/s.

$${n}_{dynamic , k} = {\sum }_{c} \{ \begin{matrix}1 & \sqrt{{v}_{x}^{( c ) 2} + {v}_{y}^{( c ) 2}} \geq 1 \\ 0 & else\end{matrix}$$

The total velocity in the grid is calculated by the equation below. The system is used to determine a sum of the velocity magnitude of all grid cells.

$${v}_{total , k} = {\sum }_{c} \sqrt{{v}_{x}^{( c ) 2} + {v}_{y}^{( c ) 2}}$$

The maximum of both of these values is the maximum value observed across all frames. The average of both of these values is the average of values across all frames. The running sum of both of these values is the sum of values of all frames. This can be represented by: *Σₖ v_{total,k}*Σₖ n_{dynamic,k}. The sum total dynamic cells/frames is the sum of the number of dynamic cells of all frames, divided by the number of frames. The sum velocity/frames is the sum of the total velocity in the grid of all frames, divided by the number of frames. The percentage (%) difference is the difference from the original algorithm case, determined by the equation below:

$$\frac{value ( γ = 1 {e}^{- 5} ) - value ( γ = 100 )}{value ( γ = 100 )}$$

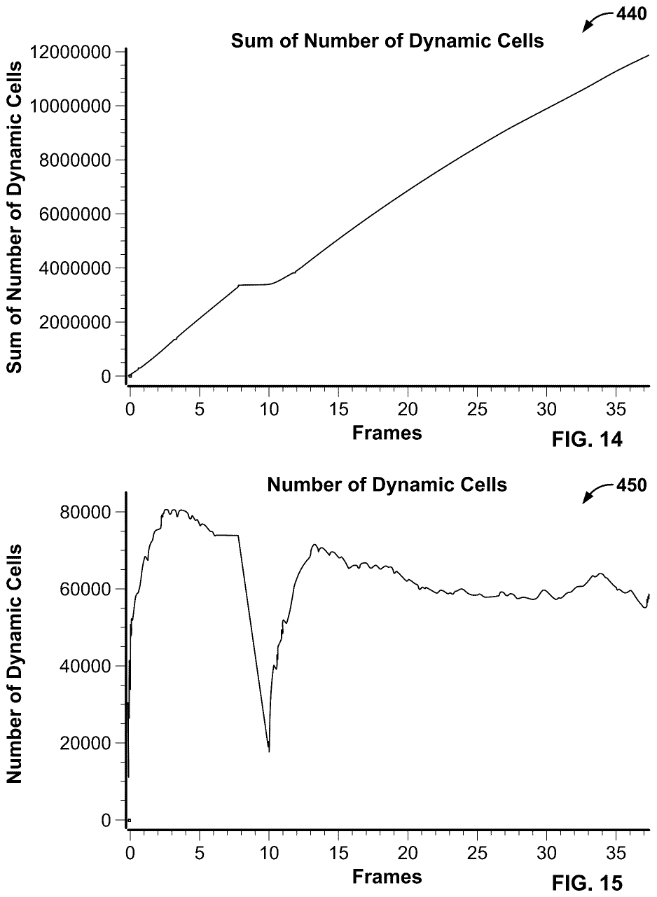

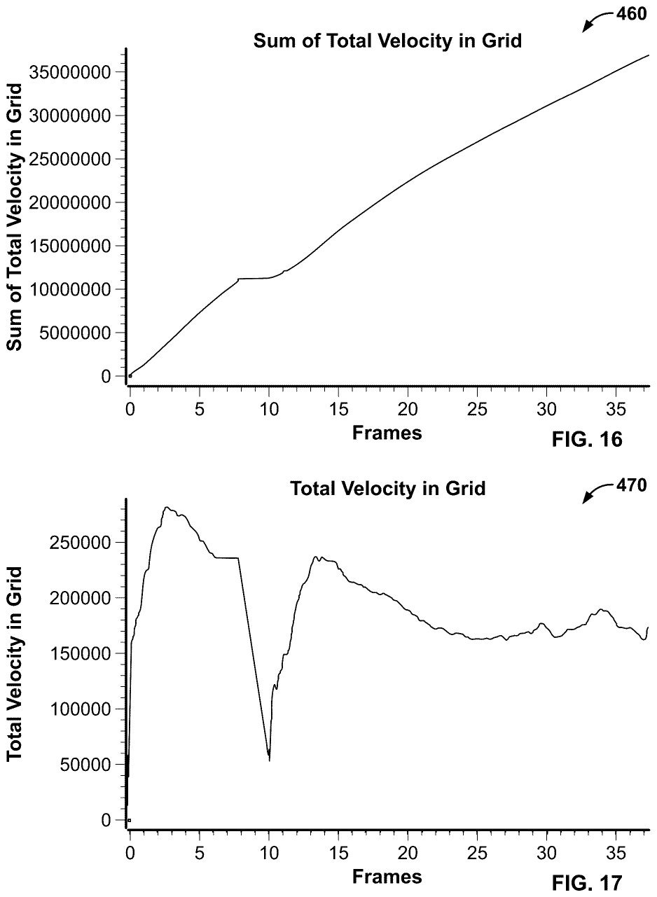

FIGS. 14-17 are example plots 440, 450, 460, 470 of the output of these values, including a sum of a number of dynamic cells (FIG. 14), a number of dynamic cells (FIG. 15), a sum of a total velocity in a grid (FIG. 16), and a total velocity in a grid (FIG. 17). For FIG. 14, the sum of the number of dynamic cells is the final value, and this value can be divided by the number of frames summed which can vary run to run, while the maximum and average number of dynamic cells is the maximum and average value of the curve in FIG. 15. In particular, FIG. 15 is the count of the number of dynamic cells, the value per frame is shown on the bottom, and the running sum of this value on the top. FIG. 16 is the sum of the total velocity magnitude in the grid, and the maximum and average velocities are shown in FIG. 17.

### Results

### Varying Thresholds

From the derivation discussed above, there is a threshold value dubbed γ used as an indicator function to determine where and when to assign a static birth particle as shown below:

$$1 ( {m}_{S}^{( c )} \geq γ ) = \{ \begin{matrix}1 & {m}_{s}^{( c )} \geq γ \\ 0 & {m}_{s}^{( c )} < γ\end{matrix}$$

Using this equation, the system produced more birth particles than configured because a birth particle was created in every cell, irrespective of whether there was any birth mass there or not. To avoid this, a modified indicator function (below) was developed which depends on the product of the determined belief of static mass times the birth mass of this cycle:

$$1 ( {m}_{S}^{( c )} \cdot {ϱ}_{b , k + 1}^{( c )} \geq γ ) = \{ \begin{matrix}1 & {m}_{s}^{( c )} \cdot {ϱ}_{b , k + 1}^{( c )} \geq γ \\ 0 & {m}_{s}^{( c )} \cdot {ϱ}_{b , k + 1}^{( c )} < γ\end{matrix}$$

When a large enough value is chosen, the function always gives 0, which makes the algorithm revert to the original one in all cells. To obtain an initial understanding of the performance of the exemplary algorithm, the value was varied and the results are presented below to pick a value to further test the performance of the system.

Collapsed sections included results suffering from deficiencies. Integration was used as it is readily available in plotting software, but can lead to erroneous results due to large gaps in data, and a direct sum as used in other sections was determined to be a better measure. The results were not normalized by the number of frames, so these values are further suspect because they are across different numbers of frames. Examining different values of the threshold γ used in the indicator function below:

$$1 ( {m}_{S , k}^{( c )} * {ϱ}_{b , k + 1}^{( c )} \geq γ )$$

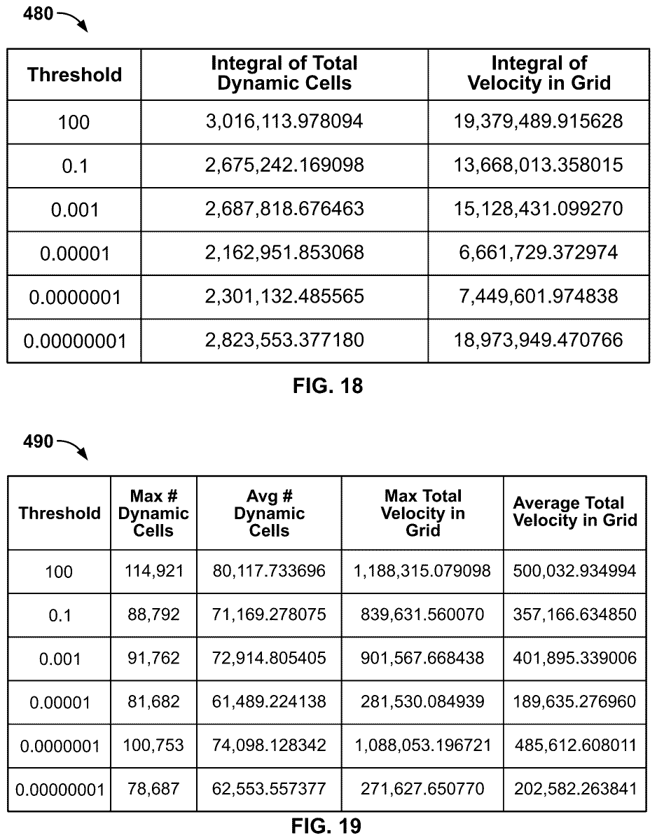

FIG. 18 is a table 480 of threshold values for an integral of total dynamic cells and integral of velocity in the grid. FIG. 19 is a table 490 of threshold values for the maximum and average number of dynamic cells, and the maximum and average total velocity in the grid.

A threshold of 100 effectively disables the exemplary algorithm and is considered equivalent to the original algorithm implementation. The value 1e-5 has the lowest result from this single sample size and was used as the candidate to examine the variability between runs at a single threshold versus the original algorithm. After performing the experimentation discussed below, it is apparent that given the high variability between test runs, a lower threshold would perform better on average.

### Variability of Results

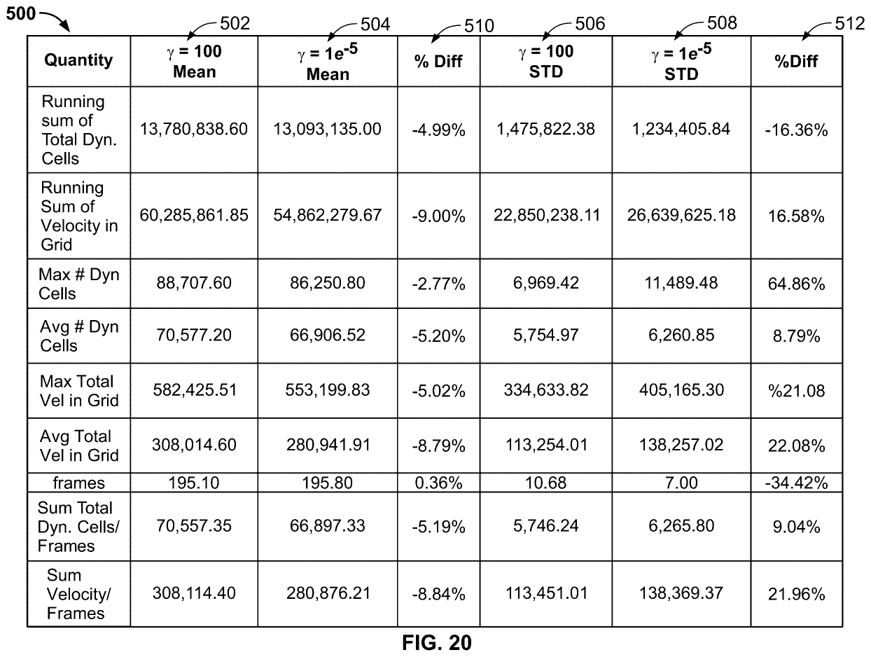

Due to the random number sampling/random process nature of the algorithm, some characterization of the variance of runs was examined. The same logged data sequence was used for each trial, which is the same from the above. From the above single test cases, the threshold level of γ=1e⁻⁵ which had the best performance was chosen to run ten instances of the same log to compare against the unmodified original algorithm case (γ=100). FIG. 20 is a table 500 of results showing the values computed across these ten trial runs for each of the algorithms. The mean 502, 504 and standard deviation 506, 508 of the trials is presented in FIG. 20, as well as the percent difference 510, 512 of the exemplary algorithm where negative percentages demonstrate improvement (compared to the original algorithm).

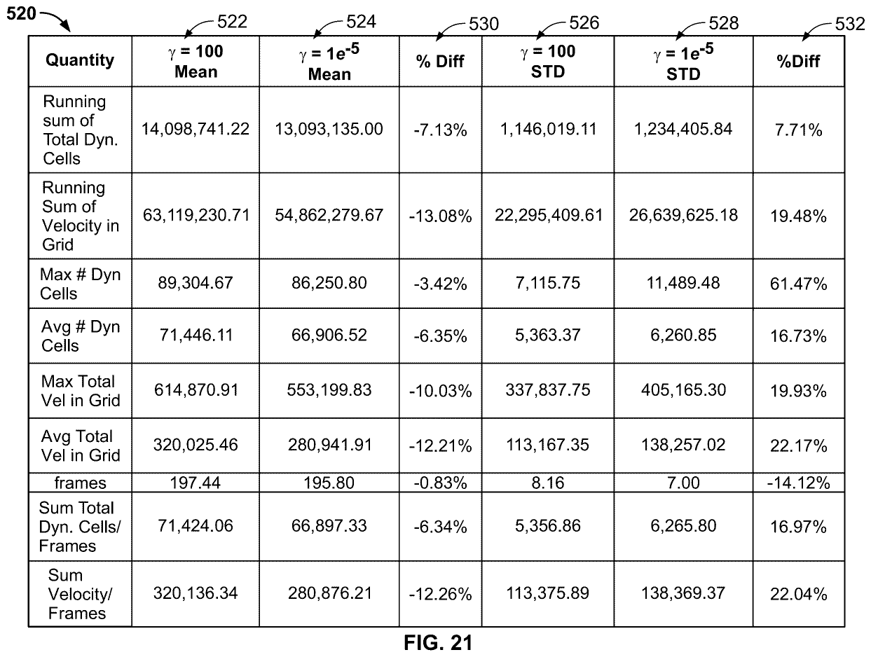

It is noted that one of the trials from the γ=100 test cases only had 174 frames, and another in the 180s. There was an issue with this log where inputs dropped out for multiple (and variable) seconds, which may be from either the input components or the input processing of the occupancy grid itself. For these cases of reduced frames, multi-drop outs were observed. There was an obvious spin up time for the cells and velocity in the grid during initialization that could lead to lower values for the running sums. Removing the erroneous trial from the analysis leads to the results in the table 520 of FIG. 21 (which includes the mean 522, 524, the standard deviation 526, 528, and the percentage difference 530, 532).

For this 41 second log, for ten trials of the original algorithm (γ=100) and the modified static birth exemplary algorithm with threshold γ=1e⁻⁵, a 5.2% decrease in the number of cells with velocity over 1 m/s per frame was observed, and an overall 8.8% decrease in the magnitude of velocity on the grid per frame was observed. When the suspect trial (trial 8) of the original algorithm was removed, this improves to a 6.4% and 12.3% decrease, respectively. The exemplary algorithm therefore identifies a greater number of static cells, which would allow for redistribution of birth particles to focus on determination of characteristics of dynamic cells (as discussed previously). It is noted that there is high variability between test cases with some having dramatically higher maximum values. This is due to a runway reaction with the random particle birth lining up with new occupancy with the slow decay of particles falsely confirming and sustaining them.

### Different Time Factors

There are a number of other parameters which could have an impact on the results when coupled with the new implementation, such as: vₘₐₓ, the maximum speed of particle initialization; r, the time factor of particle decay; p_{b}, the probability of birth; pₛ, the probability of persistence of particles; v_{b}, the total number of birth particles; and vₛ, the total number of persistent particles.

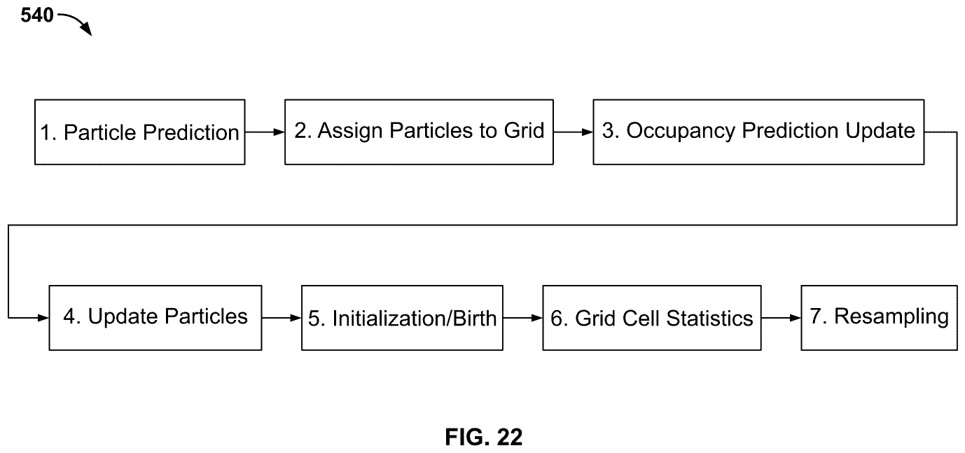

To begin, the time factor was modified, with the intuition that as its decreased, the birth process will be more important and falsely confirmed particles will die out more quickly. Examining the overall recursion algorithm helps explain this fact. In particular, FIG. 22 shows a flowchart of the recursion algorithm process 540, which includes the following: particle prediction, assign particles to grid, occupancy prediction update, update particles, initialization/birth, grid cell statistics, and resampling.

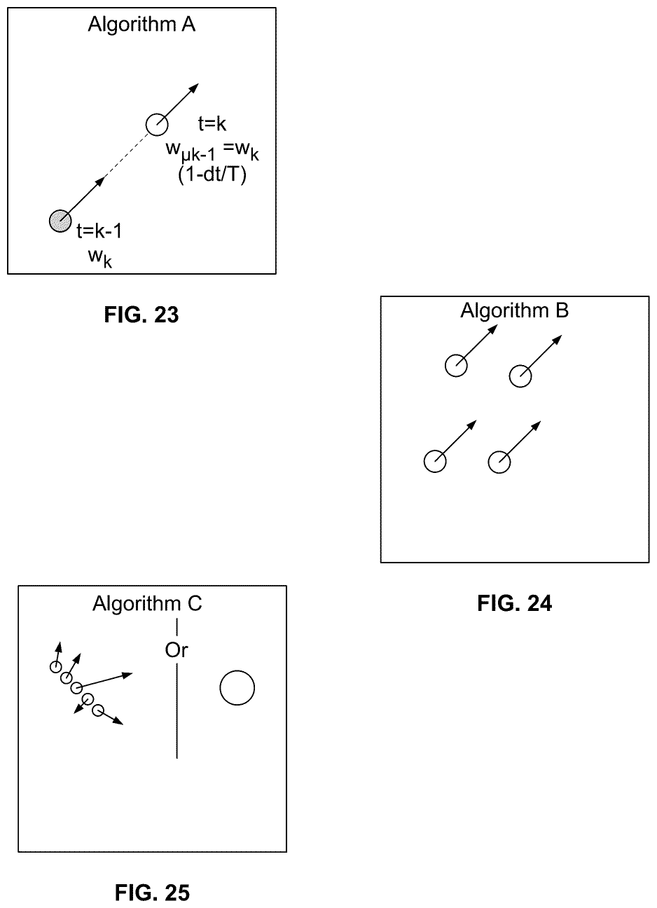

How the time factor affects and is considered by the algorithm, and why modifying the time factor is improves performance with the exemplary algorithm is shown in FIGS. 23-25. In particular, FIG. 23 is a diagram of an algorithm executed by an exemplary perception system, where a time factor controls a decay of particle mass when they are predicted. FIG. 24 is a diagram of an algorithm executed by an exemplary perception system, where if a sum of velocity wₖ of all particles in a cell is lower than expected given measurement grid input, a mass to birth new particles is created. FIG. 25 is a diagram of an algorithm executed by an exemplary perception system, where a birth mass is used to create new particles, either sampling distribution or creating more massive, static particles (or both).

FIGS. 23-25 identify different algorithms, with FIG. 23 using the algorithm identified as Algorithm A in FIG. 23, FIG. 24 using the algorithm identified as Algorithm B in FIG. 24, and FIG. 25 using the algorithm identified as Algorithm C in FIG. 25. For time factor (time_factor):

$$τ \to large ( in Alg . A ) then ↑ {w}_{k ∨ k - 1} \approx {w}_{k} and then birthmass ↓ {ϱ}_{b ∨ k + 1}^{( c )} ( in Alg . C )$$

$$τ \to small ( in Alg . A ) then ↓ {w}_{k ∨ k - 1} < {w}_{k} and then birthmass ↑ {ϱ}_{b ∨ k + 1}^{( c )} ( in Alg . C )$$

The birth mass computed in Algorithm C of FIG. 25 is used in the threshold above and therefore determines both whether to create a static birth particle, and how much mass it should contain. Therefore, by decreasing r, the amount of birth mass is increased and the birth process is more powerful.

The same two threshold levels are now compared, while lowering the time factor from 20 seconds to 5 seconds. This was hypothesized to decrease the weight of particles that persist making the birth process more dominant, and cause the exemplary algorithm to perform in an improved and optimized manner. The time factor was also varied, which causes occupancy to decay faster and makes false velocities (which spread into unknown/free space) decay quicker, thereby reducing the runaway false occupancy that occurs if the random numbers fall just right.

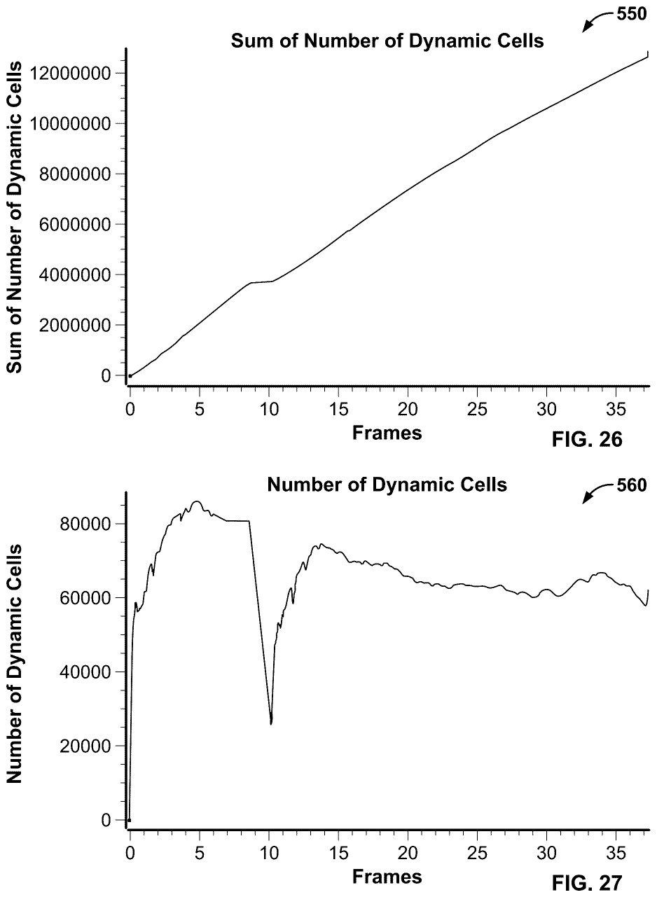

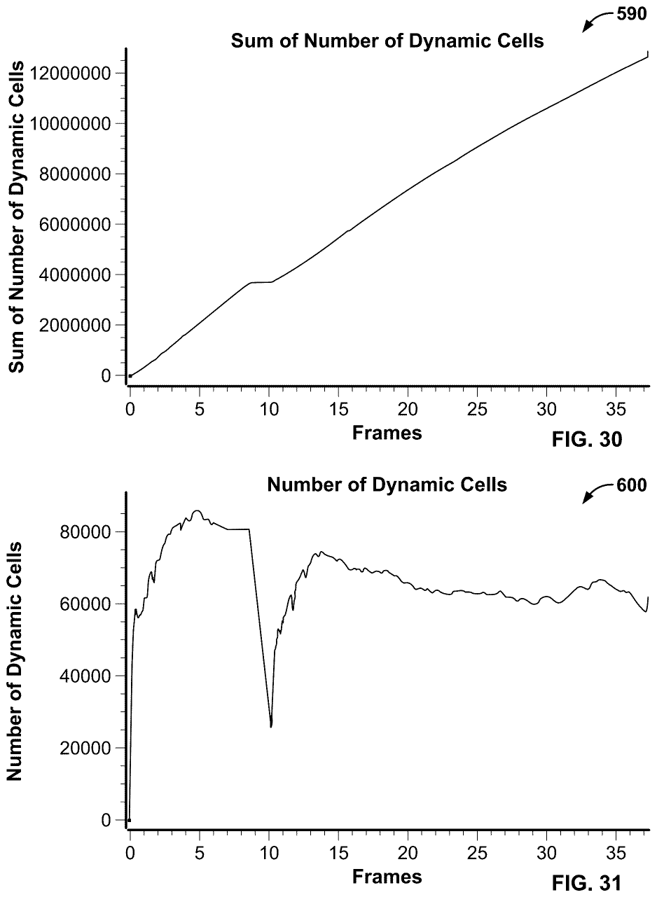

Again, ten runs were performed for each test case. FIGS. 26-29 and FIGS. 34-37 show plots 550, 560, 570, 580 and plots 630, 640, 650, 660, respectively, of the best and worst trials (trials 1 and 8, respectively) for the γ=1e⁻¹ time decay experimentation threshold cases, while FIGS. 30-33 and FIGS. 38-41 show plots 590, 600, 610, 620 and plots 670, 680, 690, 700, respectively, of the best and worst trials (trials 6 and 4, respectively) for the γ=100 time decay experimentation threshold cases. It is noted that the y-axis scales are not the same on the respective charts.

From the best trials in plots 550, 560, 570, 580, 590, 600, 610, 620 of FIGS. 26-29 and FIGS. 30-33, it can be seen that the peak of the total velocity is higher and broader for the original algorithm (γ=100), and the overall curve is higher as well (as compared to the exemplary algorithm). The number of dynamic cells also has a higher peak and is also higher overall. This indicates that the original algorithm assigns a greater number of particles and cells to dynamic objects, thereby expending greater computational abilities as compared to the exemplary algorithm.

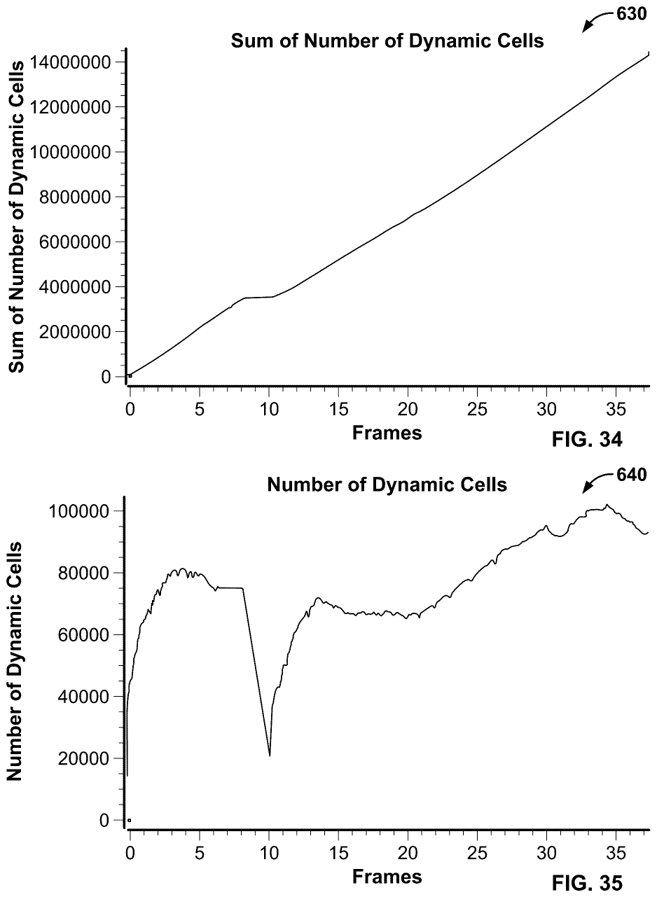

For trial number 8 in the plots 630, 640, 650, 660 of FIGS. 34-37, the “runaway” velocity can be seen at the end of the sequence where the random number birth process coincides with the direction of newly observed static masses, leading to false confirmations of particles. Though the sample size is limited, the results indicate that such false confirmations of particles are less likely to occur for the exemplary algorithm at this smaller time decay factor. The original algorithm also has this “runaway” velocity in the plots 590, 600, 610, 620 of FIGS. 30-33, and is dramatically worse overall.

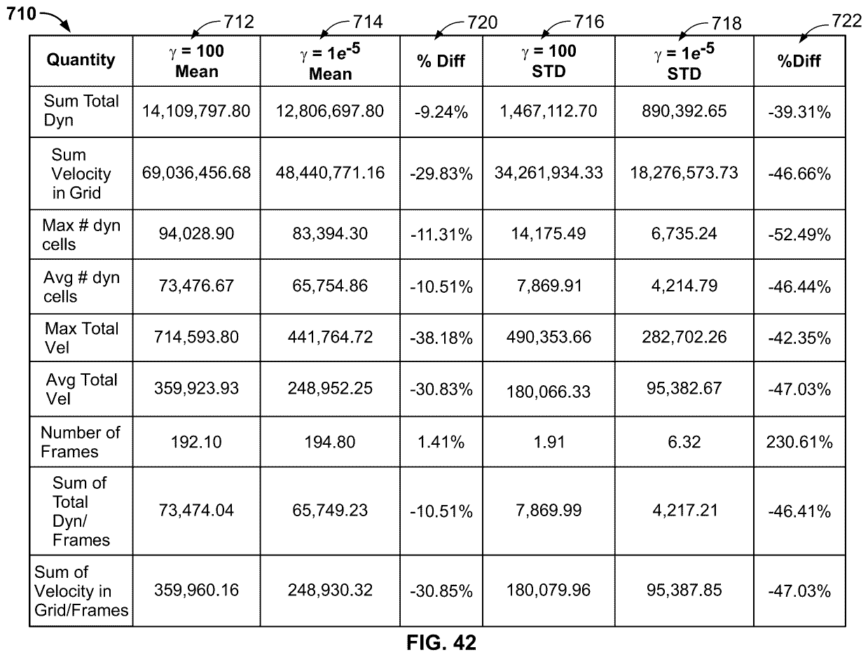

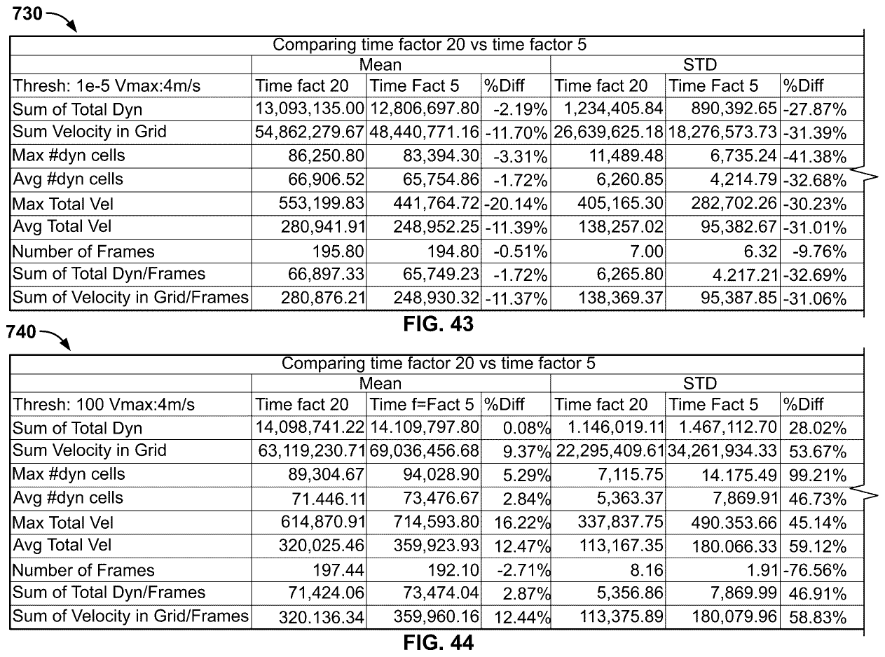

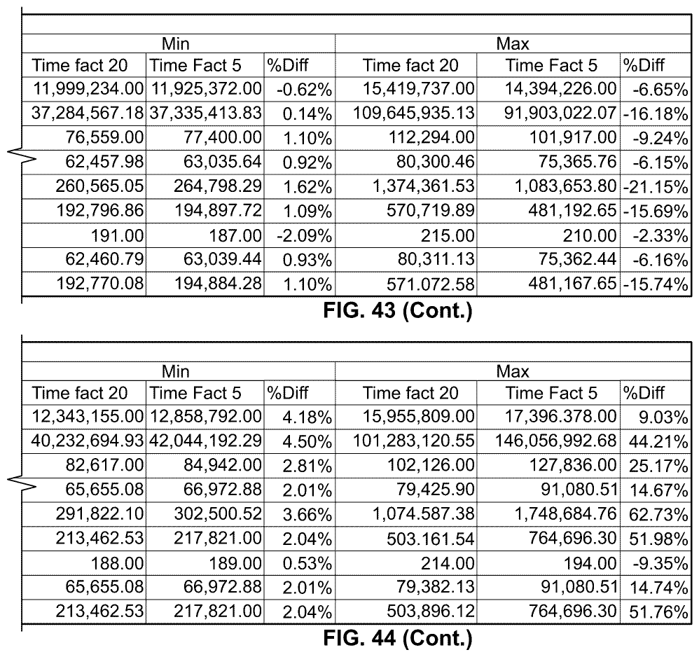

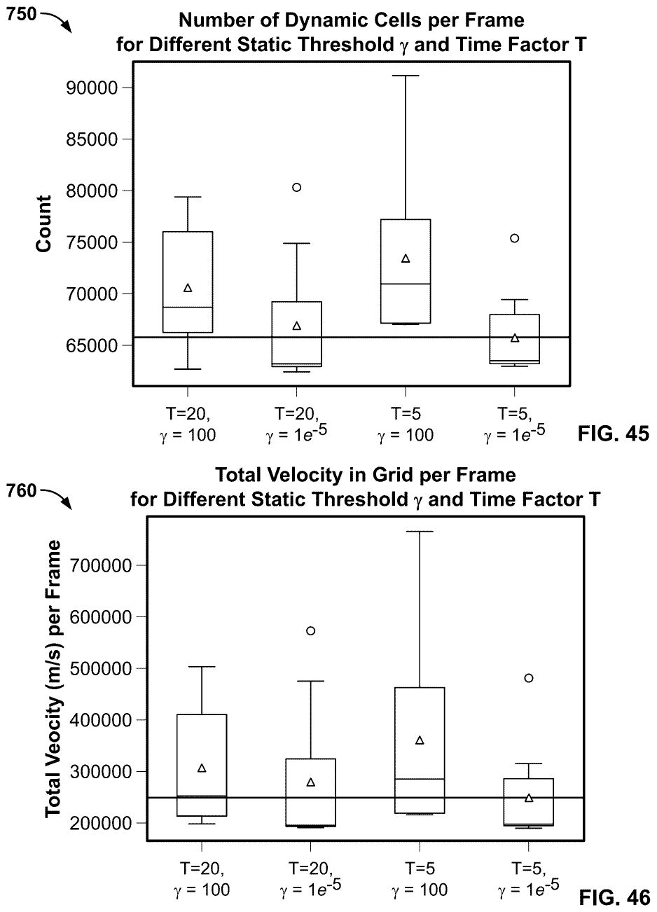

As in the previous discussion, the statistics of the two experimentation cases are provided in the table 710 of FIG. 42 (including mean 712, 714, standard deviation 716, 718, and percentage differences 720, 722). FIGS. 43 and 44 are tables 730, 740 showing results comparing the two time factors across each threshold for time factors of 20 vs. time factors of 5. FIGS. 45 and 46 are box plots 750, 760 of the number of dynamic cells per frame and the total velocity in grid per frame for different static thresholds and time factors T of 20 and 5.

As was predicted, the exemplary algorithm performed in an improved and optimized manner (compared to the original algorithm). For this case, the mean of the total number of cells with velocity of 1 m/s was 10.5% lower with the exemplary algorithm and the mean of the sum of the total velocity in the grid per frame was 30.9% less with the exemplary algorithm. Also dramatically, the standard deviation of these quantities with the exemplary algorithm was 46.4% and 47% lower, respectively. Although a small sample size of ten was used, the data indicates a smaller likelihood of the runaway false velocity.

Reducing time factor from 20 to 5 caused the sum total of velocity in the grid per frame and the total number of dynamic cells per frame to increase by 12.4% and 2.9%, respectively, for the original algorithms, likely caused by the fact that there is additional birth mass per cycle causing more new birth particles to be created. Also, the standard deviation increased for both of these values by 58.8% and 46.9%, respectively. While both the minimum and maximum value of these quantities increased, this was largely on the maximum and may be attributed to an increase in the false confirmations and runaway velocity.

In sharp contrast, the exemplary algorithm had a decrease in both the mean and the standard deviation. The sum total of dynamic cells per frame mean decreased 1.7% with a decrease in the stand deviation of 32.7%, while the sum of velocity in the grid per frame mean decreased by 11.4% and standard deviation by 31.1% versus the same threshold with a time factor of 20. It is noted that the minimum values were similar and it was the maximum values that largely decreased to bring the mean down. This suggests the exemplary algorithm with the lower time factor is less likely to have the runaway velocity. Further, it suggests that the particle resampling may keep velocity in the grid that could be stationary and that separating the static mass from the dynamic mass in the algorithm could be used to further bring the velocities down, neglecting the impact of direct Doppler measurements.

### CONCLUSION

The results show the modification to the algorithm (i.e., the exemplary algorithm) is effective in improving the amount of false velocity in the grid. The mean of the total number of dynamic cells per frame was reduced by up to 10.5% and the mean of sum of the total velocity in the grid per frame was reduced by up to 30.6%, with standard deviation reductions approaching 50% for the same time factor. Comparing the best cases of each, the 20 second time factor γ=100 and the 5 second time factor γ=1e⁻⁵ shows an improvement of 8.0% in the mean of the sum total number of dynamic cells per frame, and 22.2% in the mean of the sum of the velocity in the grid per frame. Similar results would occur when testing with moving cells.

It is noted that for all test cases and threshold levels, due to the random nature of the sampling, a run-away reaction can occur which leads to large and false velocities. The Doppler information from radar and FMCW LiDAR can help mitigate these cases. This effect was much less pronounced with the exemplary algorithm when the time factor was reduced from 20 to 5. It is possible that lowering the time factor further can also help with mitigating such cases.

It is further noted that the modification made to the algorithm only impact the birth particles, which are then resampled into the normal particle group and renormalized. The impact on performance and computation is limited, and therefore in some embodiments, the static particle distribution can be separated from the dynamic particle distribution to improve performance for dynamic objects and allow more particles and computation to be spent on them. Such separation can also eliminate the run-away reaction described above, and would also eliminate the need for the difficult to set threshold. In some instances, this could be improved at the cost of computation by looping through the birth scan twice to determine regions which would assign more than a single particle to a mostly static region. Follow up analysis can examine the impact when the maximum velocity is increased (tuning needed), results when there are dynamic vehicles present (may cause the freed up birth particles to be better spread to these moving cells instead of under-sampling distributions which could create artificially large velocities, computing results only in cells that are occupied, computing the statistics of lower thresholds to determine if they are better, and adjusting other parameters such as probability of birth.

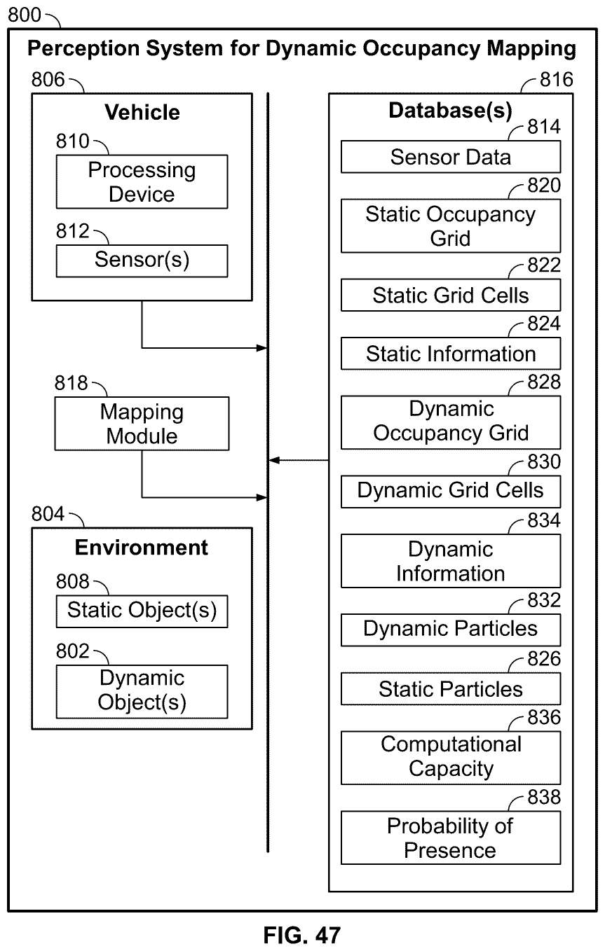

FIG. 47 is a block diagram of an exemplary perception system 800 for dynamic occupancy mapping. As discussed herein, the exemplary system 800 is intended to improve detection of dynamic objects 802 in the environment 804 around the vehicle 806 by identifying static objects 808 and focusing particle distribution on the dynamic objects 802 for computation. This allows the system 800 to operate at high speeds, providing reliable object detection for the vehicle 806.

The system 800 generally includes one or more vehicles 806 (e.g., autonomous vehicle 100) traveling through or located within an environment 804, e.g., a road, or the like. Each vehicle 806 includes a processing device 810 (e.g., computing system 200, computing system 300, or the like) configured to receive and process data for generating a dynamic occupancy map. As discussed herein, the occupancy map can be in the form of a grid (e.g., FIGS. 7, 8 and 9) representative of the environment 804. At least some of the data received by the processing device 810 can be data from one or more sensors 812 (e.g., sensors 202). For example, the sensors 812 can detect static objects 508 and dynamic objects 802 in the environment 804 as the vehicle 806 travels through the environment 804. The data 814 from the sensors 812 can be electronically stored in one or more databases 816 associated with either the vehicle 806 and/or mission control in communication with the vehicle 806.

The system 800 includes a mapping module 818 (e.g., an algorithm, or the like) executable by the processing device 810 (and/or a processing device remote from the vehicle 806, such as a processing device associated with mission control). The mapping module 818 is executable to process the data 814 to accurately identify static and dynamic objects 808, 802 around the vehicle 806, as well as characteristics associated with each of the objects 808, 802.

Using the sensor data 814, the module 818 is executed to generate a static occupancy grid 820 that is representative of the environment 804. In the grid 820, the module 818 identifies individual cells 822 in which static objects 808 are detected. The module 818 can determine that the cells 822 include a static object 808 based on one or more characteristics or information 824 associated with the objects 808. Such information 824 can include, e.g., a velocity of less than 1 m/s, a detected object type, or the like. When a static object 808 is identified in the grid 820, the module 818 assigns a single static particle 826 (having a birth mass) to the respective cell 822, thereby maintaining remaining particles for determination of characteristics associated with dynamic objects 802 in the environment 804.

The module 818 subsequently receives as input the sensor data 814 and the static occupancy grid 820 with the identified cells 822 and static particles 826, and generates a dynamic occupancy grid 828. In the grid 828, the module 818 identifies which cells 830 include the dynamic objects 802 and assigns to each respective cell 830 dynamic particles 832. The particles 832 can each include a birth mass, as well as vector information for the velocity of the particles 832. This data can be used by the module 818 to determine dynamic information 834 associated with the dynamic object 802, such as the size, velocity and direction of movement of the object 802. The database 816 can include the computational capacity 836 of the system 800, which can assist in determining how to assign dynamic particles 832, ensuring the system 800 is capable of processing the data at high speeds. The database 816 can also include the probability of presence 838, which can be used by the module 818 to assign the birth particle mass/weight to the respective cells 822, 830 and/or the particles 826, 832. In some embodiments, if the system is unable to process the data at a certain speed, an alert can be issued to the vehicle to reduce the vehicle velocity, thereby ensuring the data can be sufficiently and dynamically processed.

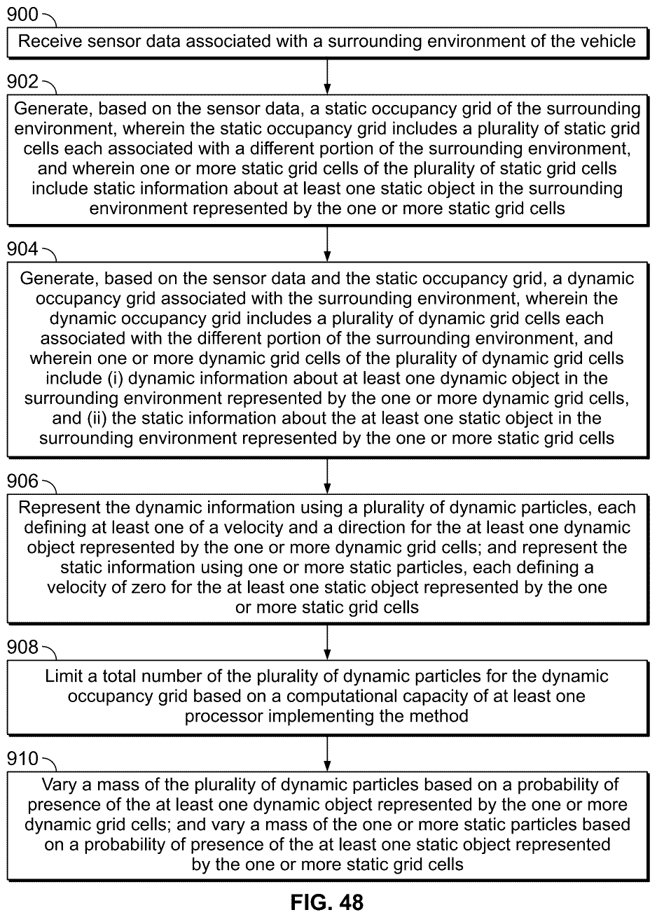

FIG. 48 is a flowchart of a method of dynamic occupancy mapping by the exemplary system 800 discussed herein. At 900, sensor data associated with a surrounding environment of the vehicle is received. At 902, based on the sensor data, a static occupancy grid of the surrounding environment is generated. The static occupancy grid includes a plurality of static grid cells each associated with a different portion of the surrounding environment. One or more static grid cells of the plurality of static grid cells include static information about at least one static object in the surrounding environment represented by the one or more static grid cells.

At 904, based on the sensor data and the static occupancy grid, a dynamic occupancy grid associated with the surrounding environment is generated. The dynamic occupancy grid includes a plurality of dynamic grid cells each associated with the different portion of the surrounding environment. One or more dynamic grid cells of the plurality of dynamic grid cells include (i) dynamic information about at least one dynamic object in the surrounding environment represented by the one or more dynamic grid cells, and (ii) the static information about the at least one static object in the surrounding environment represented by the one or more static grid cells.

At 906, the dynamic information is represented using a plurality of dynamic particles, each defining at least one of a velocity and a direction for the at least one dynamic object represented by the one or more dynamic grid cells. The system represents the static information using one or more static particles, each defining a velocity of zero for the at least one static object represented by the one or more static grid cells. At 908, a total number of the plurality of dynamic particles for the dynamic occupancy grid is limited based on a computational capacity of at least one processor implementing the method. At 910, a mass of the plurality of dynamic particles is varied based on a probability of presence of the at least one dynamic object represented by the one or more dynamic grid cells; and the system varies a mass of the one or more static particles based on a probability of presence of the at least one static object represented by the one or more static grid cells.

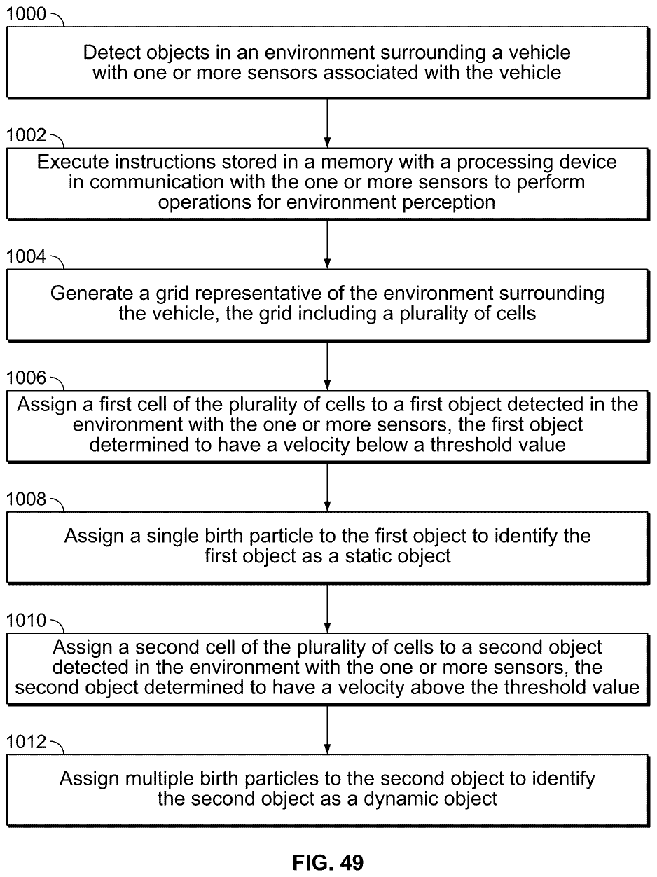

FIG. 49 is a flowchart of a method of dynamic occupancy mapping by the exemplary system 800 discussed herein. At 1000, objects in an environment surrounding a vehicle are detected with one or more sensors associated with the vehicle. At 1002, instructions stored in a memory are executed with a processing device in communication with the one or more sensors to perform operations for environment perception. At 1004, a grid representative of the environment surrounding the vehicle is generated, the grid including a plurality of cells.

At 1006, a first cell of the plurality of cells are assigned to a first object detected in the environment with the one or more sensors, the first object determined to have a velocity below a threshold value. At 1008, a single birth particle is assigned to the first object to identify the first object as a static object. At 1010, a second cell of the plurality of cells is assigned to a second object detected in the environment with the one or more sensors, the second object determined to have a velocity above the threshold value. At 1012, multiple birth particles are assigned to the second object to identify the second object as a dynamic object.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. A system for environment perception, comprising:
one or more sensors associated with a vehicle, the one or more sensors configured to detect objects in an environment surrounding the vehicle; and
a processing device in communication with the one or more sensors, wherein the processing device is configured to execute instructions stored in a memory to perform operations comprising:
generating a grid representative of the environment surrounding the vehicle, the grid including a plurality of cells;
assigning a first cell of the plurality of cells to a first object detected in the environment with the one or more sensors, the first object determined to have a velocity below a threshold value;
assigning a single birth particle to the first object to identify the first object as a static object;
assigning a second cell of the plurality of cells to a second object detected in the environment with the one or more sensors, the second object determined to have a velocity above the threshold value; and
assigning multiple birth particles to the second object to identify the second object as a dynamic object.

2. The system of claim 1, wherein the vehicle is an autonomous vehicle.

3. The system of claim 1, wherein the grid is a two-dimensional (2D) representation of the environment.

4. The system of claim 1, wherein the operations comprise updating the generated grid in real-time based on movement of the vehicle through the environment.

5. The system of claim 1, wherein the threshold value is 1 m/s.

6. The system of claim 1, wherein the operations comprise assigning a first set of birth particles to the first object and, upon a determination that the velocity of the first object is below the threshold value, converting the first set of birth particles to the single birth particle.

7. The system of claim 6, wherein the first set of birth particles is equal to a number of the multiple birth particles assigned to the second object.

8. The system of claim 6, wherein the operations comprise transferring birth particles from the first set of birth particles to the multiple birth particles associated with the second object after conversion of the first set of birth particles to the single birth particle.

9. The system of claim 8, wherein transferring the birth particles from the first set of birth particles to the multiple birth particles increases accuracy of dynamic information acquired for the second object.

10. The system of claim 1, wherein each of the multiple birth particles associated with the second object includes a velocity and a direction.

11. The system of claim 10, wherein the operations comprise generating a true velocity and true direction of the second object based on the velocity and direction for each of the multiple birth particles associated with the second object.

12. The system of claim 1, wherein a mass of the single birth particle assigned to the first object is greater than a mass of each of the multiple birth particles assigned to the second object.

13. The system of claim 1, wherein as the vehicle moves through the environment, the operations comprise focusing movement computation on only the dynamic object and maintaining identification of the first object as a static object.

14. The system of claim 1, wherein the operations comprise assigning excess birth particles to the first object to resample dynamic characteristics associated with the first object and determine if a resampled velocity of the first object is above the threshold value.

15. The system of claim 14, wherein if the resampled velocity of the first object is below the threshold value, the first object is maintained as the static object.

16. The system of claim 14, wherein if the resampled velocity of the first object is above the threshold value, the operations comprise identifying the first object as a resampled dynamic object.

17. The system of claim 1, wherein the operations comprise updating a mass of the multiple birth particles assigned to the second object based on a probability of presence of the dynamic object.

18. A computer-implemented method for environment perception, the method comprising:
detecting objects in an environment surrounding a vehicle with one or more sensors associated with the vehicle; and
executing instructions stored in a memory with a processing device in communication with the one or more sensors to perform operations comprising:
generating a grid representative of the environment surrounding the vehicle, the grid including a plurality of cells;
assigning a first cell of the plurality of cells to a first object detected in the environment with the one or more sensors, the first object determined to have a velocity below a threshold value;
assigning a single birth particle to the first object to identify the first object as a static object;
assigning a second cell of the plurality of cells to a second object detected in the environment with the one or more sensors, the second object determined to have a velocity above the threshold value; and
assigning multiple birth particles to the second object to identify the second object as a dynamic object.

19. The computer-implemented method of claim 18, wherein the operations comprise assigning a first set of birth particles to the first object and, upon a determination that the velocity of the first object is below the threshold value, converting the first set of birth particles to the single birth particle.

20. The computer-implemented method of claim 19, wherein the operations comprise transferring birth particles from the first set of birth particles to the multiple birth particles associated with the second object after conversion of the first set of birth particles to the single birth particle.
